(19) United States
(12) Patent Application Publication
(10) Pub. No.: US 2024/0420725 A1
(43) Pub. Date: Dec. 19, 2024

(54) Audio Analytics System And Methods Of Use Thereof

(71) Applicant: VoxEQ, Inc., Jacksonville, FL (US)

(72) Inventors: John W. Caven, III, Jacksonville, FL (US); Christopher K. Eveland, Nashville, TN (US)

(21) Appl. No.: 18/739,555

(22) Filed: Jun. 11, 2024

Related U.S. Application Data
(60) Provisional application No. 63/521,625, filed on Jun. 16, 2023.

(51) Int. Cl. G10L 25/60; G10L 17/02; G10L 25/30; G10L 25/63; G10L 25/66

(52) U.S. Cl. CPC G10L 25/60; G10L 17/02; G10L 25/30; G10L 25/63; G10L 25/66

(57) ABSTRACT

The present disclosure provides for an audio analytics system. The audio analytics system may comprise at least one audio capture device configured to capture at least one audio source emitted from at least one origin. By executing one or more operations on the audio source, the audio analytics system may identify one or more potential origin characteristics related to the origin of the audio source. The identified potential origin characteristics may be compared to one or more expected origin characteristics of the origin of the audio source to determine one or more origin characteristic results. If at least one discrepancy exists between the identified potential origin characteristics and the expected origin characteristics, the audio analytics system may identify the audio source as being potentially fraudulent.

### CROSS-REFERENCE TO RELATED APPLICATION

This application claims priority to and the full benefit of U.S. Provisional Patent Application Ser. No. 63/521,625 (filed Jun. 16, 2023, and titled “AUDIO ANALYTICS SYSTEM AND METHODS OF USE THEREOF”), the entire contents of which are incorporated in this application by reference.

### BACKGROUND

In the early 2000s, following the attacks of 9/11, the United States government pushed the development of speech analytic technology. Looking to track individuals and organizations under surveillance, new ways to scan audio files for specific words or phrases were developed. Despite the initially poor accuracy of these technologies, a new era of security, surveillance, and convenience began. Nowadays, it has become the norm to encounter speech recognition and audio analytic software in many aspects of everyday life, whether that be in personal or professional settings. The current versions of speech analytic technology boast incredible accuracy in their ability to understand and process voice recordings. This accuracy has led to the widespread use of voice recognition software in many convenience-based applications; however, the impressive performance of modern voice recognition technology has yet to be satisfactorily implemented in security settings. The latest challenge for speech analytic technology is whether it can effectively rout out different types of fraudulent behavior by bad actors.

Recorded attempts at fraud date back to 300 B.C. Fraudulent occurrences have consistently adapted to societal changes as fraudsters continuously adapt and take advantage of new methods and technologies. In the 1980s, as the world transitioned into the digital age, an entirely new form of fraud emerged. Fraudsters began exploiting telephones, online credit card services, ATM machines, cryptocurrency systems, and more. With the more recent development of artificial intelligence and audio analytics tools, both new ways of committing fraud and new ways of defending against fraud have surfaced. As a reference, in 2020, the World Trade Organization estimated global fraud, including money laundering, to be more than $5 trillion USD.

Voice recognition technology has already been established as a useful tool against fraudsters. There are two main applications of voice recognition technology in fraud prevention: (1) verification and authentication; (2) identification. Verification and authentication involve the matching of prerecorded or preexisting voice data, such as a voiceprint, and matching it to a particular speaker, either confirming or denying the existence of a match. Alternatively, during a an identification process, the voice of an unknown speaker may be analyzed and compared to known speakers, with an attempt to try and match an unknown speaker to existing data. Businesses dealing with sensitive data have adopted various versions of these technologies, requiring their users to offer a voice recording that can be used for future verification and authentication purposes.

While these voice recognition technologies offer a notable level of security, fraudsters have found ways around them, thereby creating risk for billions of users. The utility and accuracy of the existing voice recognition systems rely almost entirely on obtaining prerecorded data from registered users. This significantly limits the data set available to a voice recognition system, causing the system's performance to be severely limited. Additionally, the vulnerabilities of these systems are often exploited by fraudsters who deploy a variety of strategies to defeat these systems, such as by illegitimately enrolling a voice before a legitimate customer can do so. Furthermore, the development of sophisticated voice cloning software, synthetic voice software, audio deepfakes and vocal disguises has given bad actors a readily available means to circumvent most voice-based security systems. Using generative artificial intelligence, audio deepfakes can create very convincing speech recordings that can circumvent common voice security technologies.

The deficiency in audio analytics is rooted in the methods of data capture and system training. By relying on users to provide data, voice recognition technologies are limited in their strength and application. The current technology does not provide security to individuals who have not yet provided their data to a voice recognition system, leaving them vulnerable to fraud. A method of audio analytics that does not rely on obtaining a user's voice recording(s) in advance is needed. One that can identify a speaker who has not yet offered a voice sample is also desired.

### SUMMARY OF THE DISCLOSURE

What is needed is a system that replicates, mimics, and supplements the innate human ability to analyze audio sources to determine one or more characteristics of the audio sources or the origins of the audio sources. A system configured to capture and analyze one or more audio or visual sources may allow one or more potential origin characteristics of one or more origins of the audio or visual sources to be identified, such as, for example and not limitation, the identity, one or more physical characteristics based on unique vibrations emitted from the vocal tract, age, gender, sex, hormonal development, race, ethnicity, weight, or height of the origin of the audio or visual source(s). Such a system may supplement or surpass the human capability to analyze audio and visual sources by executing at least one operation on the audio or visual source(s) to identify the potential origin characteristic(s) that may be associated with the origin(s) of the audio or visual source(s). The system may be implemented in a variety of settings, including conversations; telephonic conversations, such as those involving government agencies or financial services institutions; security assessments; equipment and vehicle control systems; online communities; the metaverse; forensics; intelligence; or health care environments, as non-limiting examples.

The present disclosure provides for audio analytics systems and methods of use thereof. In some aspects, an audio analytics system may comprise one or more audio sources. In some implementations, the audio analytics system may comprise at least one audio capture device. In some non-limiting exemplary embodiments, the at least one audio capture device may be configured to receive one or more audio sources and execute at least one operation on the audio source(s). In some aspects, execution of the at least one operation may enable the audio analytics system to identify one or more potential origin characteristics associated with an origin of an audio source. By way of example and not limitation, a potential origin characteristic may comprise one or more of: a physical, mental, or emotional condition of the audio source origin. By way of further example and not limitation, a potential origin characteristic may comprise at least one of: an age, an age range, a height, a height range, a weight, a weight range, a gender, a sex, a hormonal development, a race, an ethnicity, or an identification of the origin of the audio source.

In some embodiments, the audio capture device of the audio analytics system of the present disclosure may comprise at least one storage medium, which, in some aspects, may at least partially comprise volatile memory for streaming data, wherein the at least one storage medium may comprise one or more parameters that may be utilized to at least partially execute the at least one operation on the received audio source(s). By way of example and not limitation, the parameter(s) within the storage medium may comprise one or more weights, biases, or similar values, modifiers, or inputs. In some non-limiting exemplary embodiments, at least a portion of the one or more parameters may be adjustable to modify the accuracy of the potential origin characteristic(s) identified via the execution of the at least one operation on the received audio source(s).

In some implementations, the audio capture device of the audio analytics system of the present disclosure may be communicatively coupled to at least one artificial intelligence infrastructure. In some non-limiting exemplary embodiments, the audio capture device may comprise at least one artificial intelligence infrastructure. In some aspects, the artificial intelligence infrastructure may be configured to at least partially execute the at least one operation on the received audio source(s). In some implementations, the artificial intelligence infrastructure may be stored within one or more external or remote computing devices or servers that may be communicatively coupled to the audio capture device via at least one network connection. By way of example and not limitation, the network connection may comprise a connection to the global, public Internet or a private local area network (“LAN”). In some non-limiting exemplary embodiments, the artificial intelligence infrastructure may be stored within one or more external or remote computing devices or servers that may be communicatively coupled to the audio capture device directly without any network connection, such as, for example and not limitation, in a disconnected edge computing environment. In some implementations, by way of example and not limitation, the artificial intelligence infrastructure may comprise at least one of: a neural network, a deep neural network, a convolutional neural network, and a support vector machine.

In some aspects, the audio analytics system of the present disclosure may be configured to identify or determine one or more audio characteristics of the received audio source(s). In some implementations, the audio characteristic(s) may be identified via execution of a first at least one operation on the received audio source(s) and a second at least one operation may be executed on the identified audio characteristic(s) to identify the potential origin characteristic(s) associated with the origin(s) of the audio source(s). In some embodiments, the audio characteristics of the audio source may be determined via one or more analytical processes that may be at least partially facilitated by one or more algorithms or software instructions. In some aspects, the audio analytics system may be configured to execute at least one operation directly on the received audio source(s) to identify the potential origin characteristic(s) of the origin(s) of the audio source(s).

In some non-limiting exemplary embodiments, a first at least one operation may be at least partially executed an a received audio source via a first artificial intelligence infrastructure utilizing a first set of one or more parameters and a second at least one operation may be at least partially executed by a second artificial intelligence infrastructure utilizing a second set of one or more parameters. In some implementations, the first and the second at least one operation may be at least partially executed by the same artificial intelligence infrastructure using the same or different sets of one or more parameters. In some aspects, execution of the first at least one operation may identify one or more audio characteristics of the audio source or a first set of one or more potential origin characteristics of the origin of the audio source, while execution of the second at least one operation may identify a first or second set of one or more potential origin characteristics of the origin of the audio source.

In some implementations, the artificial intelligence infrastructure of the audio analytics system of the present disclosure may be at least partially trained using an amount of training data, wherein the amount of training data may be derived from a plurality of training sources, wherein each of the plurality of training sources may comprise at least one type or form of sound or audio that comprises one or more sound waves. In some non-limiting exemplary embodiments, the artificial intelligence infrastructure may comprise at least three layers, wherein each layer may comprise one or more nodes. By way of example and not limitation the artificial intelligence infrastructure may comprise at least one input layer, at least one output layer, and one or more hidden intermediate layers. In some aspects, the nodes of one layer may be connected to the nodes of an adjacent layer via one or more channels. In some implementations, each channel may be assigned a numerical value, or weight. In some embodiments, each node within the one or more intermediate layers may be assigned a numerical value, or bias. Collectively, the weights of the channels and the biases of the nodes may comprise one or more parameters of the audio analytics system.

In some aspects, the training data may be received by the input layer of the artificial intelligence infrastructure. In some implementations, the audio analytics system may then execute one or more operations on the training data as the training data is propagated through the one or more intermediate layers, wherein the one or more operations may incorporate the parameters of the audio analytics system during execution. In some embodiments, once the training data reaches the output layer of the artificial intelligence infrastructure, one or more potential origin characteristics associated with the training data may be identified.

In some implementations, the audio analytics system of the present disclosure may be trained via at least one semi-supervised machine learning process. In some aspects, the semi-supervised machine learning process may utilize one or more pseudo-labeling techniques. In some non-limiting exemplary embodiments, each potential origin characteristic identified for the training data received by the audio analytics system may be compared to at least one of: a known (or labeled) origin characteristic for the training data and an estimated (or pseudo-labeled) origin characteristic of the training data. In some aspects, this comparison may allow the audio analytics system to determine if each identified potential origin characteristic of the training data is accurate or inaccurate. In some implementations, if an identified potential origin characteristic is determined to be inaccurate, the audio analytics system may perform one or more calculations to assess the degree or nature of the inaccuracy. In some aspects, the data resulting from this assessment may be directed back through the artificial intelligence infrastructure via at least one backpropagation algorithm. In some non-limiting exemplary embodiments, the at least one backpropagation algorithm may adjust the one or more weights, biases, or other parameters of the audio analytics system to generate more accurate results for subsequently received training data obtained from one or more training sources. In some aspects, the utilization of at least one semi-supervised machine learning process may enable the audio analytics system to process a greater amount of training data from more training sources.

In some aspects, at least a portion of the training data derived from the training sources received by the audio analytics system may be at least partially augmented. In some non-limiting exemplary embodiments, augmenting the training data may at least partially comprise replicating and applying one or more audio quality influencers to the training sources, wherein the audio quality influencers may comprise one or more factors that may affect the quality of an audio source. By way of example and not limitation, an audio quality influencer may comprise compression applied to audio sources transmitted via at least one cellular telephone system or one or more user communication services operating on one or more mobile computing devices (such as the WhatsApp® service available from Meta of Menlo Park, CA, a social media network, or a virtual gaming environment, as non-limiting examples).

In some implementations, the determination of the accuracy of the one or more potential origin characteristics identified for each training source received by the audio analytics system of the present disclosure may at least partially comprise the execution of at least one loss function. In some aspects, the at least one loss function may be configured to simultaneously determine classification loss and regression loss for each identified potential origin characteristic such that the audio analytics system may be trained to accurately predict at least one class and/or at least one distribution range for one or more of the potential origin characteristics. In some non-limiting exemplary embodiments, the at least one loss function may at least partially comprise at least one linear quadratic estimation algorithm.

In some implementations, the audio analytics system of the present disclosure may be configured to determine and present one or more scores describing a quantified accuracy approximation of one or more results, such as, for example and not limitation, one or more identified potential origin characteristics produced by the audio analytics system. In some aspects, by way of example and not limitation, each score may comprise a numerical value, percentage, or Gaussian distribution representing a calculated estimated accuracy of the one or more identified potential origin characteristics.

In some implementations, the audio analytics system of the present disclosure may comprise at least one visual capture device configured to capture one or more visual sources, wherein the visual source(s) may comprise one or more images associated with or representative of one or more origins of one or more audio sources. In some non-limiting exemplary embodiments, the audio analytics system may be configured to match the one or more visual sources with one or more origins, and vice versa.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates an exemplary audio analytics system, according to some embodiments of the present disclosure.

FIG. 2 illustrates an exemplary audio analytics system, according to some embodiments of the present disclosure.

FIG. 3A illustrates exemplary scores of an audio analytics system, according to some embodiments of the present disclosure.

FIG. 3B illustrates exemplary scores of an audio analytics system, according to some embodiments of the present disclosure.

FIG. 4 illustrates an exemplary audio analytics system, according to some embodiments of the present disclosure.

FIG. 5 illustrates an exemplary origin characteristic result determined by an audio analytics system, according to some embodiments of the present disclosure.

FIG. 6 illustrates an exemplary audio analytics system comprising an audio source and an audio capture device, according to some embodiments of the present disclosure.

FIG. 7A illustrates an exemplary audio analytics system comprising an audio source and an audio capture device, according to some embodiments of the present disclosure.

FIG. 7B illustrates an exemplary audio analytics system comprising an audio source and an audio capture device, according to some embodiments of the present disclosure.

FIG. 7C illustrates an exemplary audio analytics system comprising an audio source and an audio capture device, according to some embodiments of the present disclosure.

FIG. 8A illustrates an exemplary audio analytics system comprising an audio source and an audio capture device, according to some embodiments of the present disclosure.

FIG. 8B illustrates an exemplary audio analytics system comprising an audio source and an audio capture device, according to some embodiments of the present disclosure.

FIG. 9 illustrates an exemplary audio analytics system comprising two or more audio sources, according to some embodiments of the present disclosure.

FIG. 10 illustrates an exemplary audio analytics system comprising two or more audio sources, according to some embodiments of the present disclosure.

FIG. 11 illustrates an exemplary audio analytics system comprising an audio source, according to some embodiments of the present disclosure.

FIG. 12A illustrates an exemplary audio analytics system comprising two or more audio sources, according to some embodiments of the present disclosure.

FIG. 12B illustrates an exemplary audio analytics system comprising two or more audio sources, according to some embodiments of the present disclosure.

FIG. 13 illustrates a block diagram of an exemplary computing device that may at least partially comprise an audio analytics system, according to some embodiments of the present disclosure.

FIG. 14 illustrates an exemplary process for analyzing audio, according to some embodiments of the present disclosure.

FIG. 15 illustrates an exemplary process for identifying a potentially fraudulent audio source, according to some embodiments of the present disclosure.

FIG. 16 illustrates an exemplary process for analyzing audio, according to some embodiments of the present disclosure.

The Figures are not necessarily drawn to scale, as their dimensions can be varied considerably without departing from the scope of the present disclosure.

### DETAILED DESCRIPTION

In the following sections, detailed descriptions of examples and methods of the disclosure will be given. The descriptions of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Audio Characteristic: as used herein refers to at least one aspect of an audio source. In some aspects, an audio characteristic may comprise volume, tone, rhythm, inflection, pitch, base, frequency, or one or more image processing analytics, as non-limiting examples.

Origin Characteristic: as used herein refers to at least one physical, mental, or emotional characteristic associated with an origin of at least one audio source. In some aspects, an origin characteristic may comprise an age, age range, height, weight, gender, sex, hormonal development, race, ethnicity, identification, emotional state, mental state, fatigued status, or level of neurological impairment of an origin, as non-limiting examples.

Audio Source: as used herein refers to any auditory sound emitted by at least one origin, wherein an origin may comprise the originator of the auditory sound. In some non-limiting exemplary embodiments, an audio source may comprise a human voice. In some aspects, by way of example and not limitation, an audio source may comprise a previously emitted auditory sound stored within at least one storage medium. In some aspects, by way of further example and not limitation, an audio source may at least partially comprise a live audio stream.

Audio Capture Device: as used herein refers to any device used to capture or receive at least one audio source. By way of example and not limitation, an audio capturing device may comprise a microphone, camera, or a recording device.

Operation: as used herein refers to any action that may be executed on at least one audio source by at least one computing device. By way of example and not limitation, an operation may comprise any function, process, procedure, algorithm, artificial intelligence application, or machine learning process that may be used to at least partially analyze at least one audio source. By way of further example and not limitation, an operation may be executed during the performance of a neural network or support vector machine.

Parameter: as used herein refers to any element that may influence an operation executed by at least one computing device. In some aspects, a parameter may comprise one or more weights, one or more biases, one or more values, and/or one or more inputs.

Embedding: as used herein, refers to a condensed data set comprising one or more origin characteristics at least partially derived from at least one audio source. In some embodiments, an embedding may comprise a resultant data set produced after an audio source is processed by at least one artificial intelligence infrastructure. In some implementations, an embedding may comprise audio source data that excludes information that is irrelevant to any origin characteristics of an origin of an audio source, such as, for example and not limitation, the content of one or more spoken sounds or background noise, as non-limiting examples.

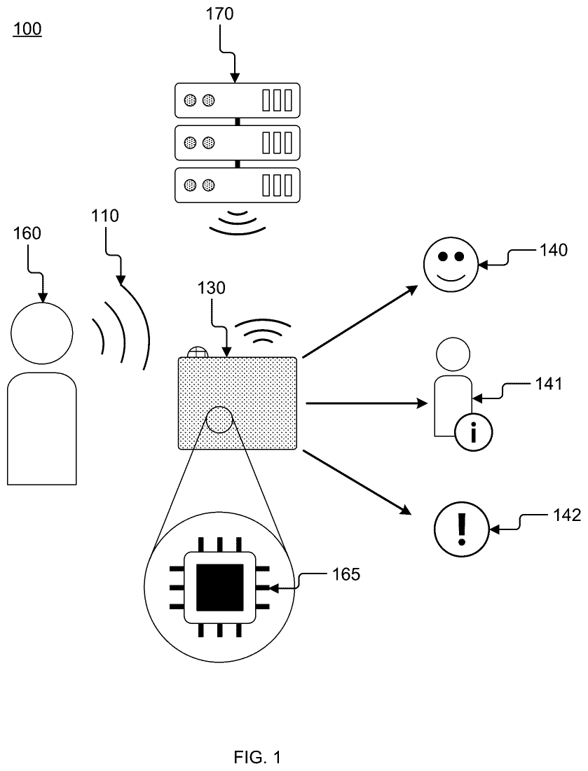

Referring now to FIG. 1, an exemplary audio analytics system 100, according to some embodiments of the present disclosure, is illustrated. In some aspects, the audio analytics system 100 may comprise at least one audio source 110. In some implementations, the audio analytics system 100 may comprise at least one audio capture device 130. In some implementations, the audio analytics system 100 may be configured to identify one or more potential origin characteristics 140, 141, 142 associated with an origin 160 of the audio source 110, wherein the potential origin characteristics 140, 141, 142 may be presented to at least one user of the audio analytics system 100. In some embodiments, the audio capture device 130 may at least partially comprise at least one computing device. In some implementations, the audio capture device 130 may be communicatively coupled to at least one computing device, such as via a wireless connection or a hardwired connection, as non-limiting examples. In some non-limiting exemplary embodiments, the audio capture device 130 may at least partially comprise or may be communicatively coupled to at least one computing device that comprises one or more of: a central processing unit (“CPU”), a graphics processing unit (“GPU”), an edge computing device, a system on a chip, a tensor core, a headset, an on-board vehicle computer, a smartphone, a laptop computer, a tablet computer, a desktop computer, a gaming console, a smart speaker, or a hearing aid, as non-limiting examples. In some aspects, the audio capture device 130 may comprise at least one of: a peripheral device and a sensing device.

In some implementations, the audio capture device 130 may be configured to receive at least one audio source 110. By way of example and not limitation, the audio capture device 130 may receive the audio source 110 via at least one input element, such as a microphone or network connection, as non-limiting examples. In some aspects, the audio analytics system 100 may be configured to execute at least one operation on the audio source 110, wherein execution of the at least one operation may allow the audio analytics system 100 to identify one or more potential origin characteristics 140, 141, 142 associated with an origin 160 of the audio source 110. By way of example and not limitation, potential origin characteristics 140, 141, 142 may comprise a physical, mental, or emotional status associated with the origin 160 of the audio source 110. By way of further example and not limitation, potential origin characteristics 140, 141, 142 may comprise one or more of: an age, age range, height, height range, weight, weight range, gender, sex, hormonal development, race, ethnicity, or identification of the origin 160 of the audio source 110.

In some aspects, the audio analytics system 100 may comprise at least one storage medium 165. In some implementations, the storage medium 165 may comprise one or more parameters that may be used or referenced during the execution of the operations on the audio source 110. In some non-limiting exemplary embodiments, the parameters may comprise one or more weights, biases, or similar values, modifiers, or inputs. In some aspects, at least a portion of the parameters may be adjustable to improve the accuracy of the potential origin characteristics 140, 141, 142 identified for the origin 160 of the audio source 110.

In some implementations, the audio analytics system 100 may comprise at least one artificial intelligence infrastructure. In some non-limiting exemplary embodiments, the artificial intelligence infrastructure may be communicatively coupled to the audio capture device 130. In some implementations, the audio capture device 130 may comprise the artificial intelligence infrastructure. In some aspects, the artificial intelligence infrastructure may be configured to at least partially execute the at least one operation on the audio source 110. In some embodiments, the artificial intelligence infrastructure may be at least partially configured within one or more external or remote computing devices or servers 170 that may be communicatively coupled to the audio capture device 130 via at least one network connection, such as, for example and not limitation, via the global, public Internet or via a local area connection (LAN), or via at least one direct connection. By way of example and not limitation, the artificial intelligence infrastructure may comprise at least one of: a neural network, a deep neural network, a convolutional neural network, and a support vector machine. By way of further example and not limitation, the artificial intelligence infrastructure may be at least partially configured within at least one computing device that comprises one or more of: a central processing unit (“CPU”), a graphics processing unit (“GPU”), an edge computing device, a system on a chip, or a tensor core, as non-limiting examples.

In some aspects, the audio analytics system 100 may comprise a plurality of artificial intelligence infrastructures. In some non-limiting exemplary embodiments, the audio analytics system 100 may comprise a first artificial intelligence infrastructure and a second artificial intelligence infrastructure. In some implementations, the first artificial intelligence infrastructure may be configured to at least partially execute a first at least one operation on the audio source 110 using a first set of parameters and the second artificial intelligence infrastructure may be configured to at least partially execute a second at least one operation on the audio source 110 using a second set of parameters.

In some embodiments, the first artificial intelligence infrastructure of the audio analytics system 100 may be configured to identify one or more audio characteristics of the audio source 110. In some implementations, the audio characteristics may be identified via a first at least one operation that may be executed on the audio source 110 and a second at least one operation may be executed on the identified audio characteristics of the audio source 110 to identify one or more potential origin characteristics 140, 141, 142 associated with an origin 160 of the audio source 110. In some aspects, at least one operation may be executed directly on the audio source 110 to identify one or more potential origin characteristics without first identifying any audio characteristics. In some implementations, one or more audio characteristics may be identified or determined for the audio source 110 by one or more processes or analytical methods that do not comprise executing at least one operation on the audio source 110. By way of example and not limitation, audio characteristics of the audio source 110 may comprise one or more of: volume, tone, rhythm, inflection, pitch, base, vibrational frequency, image processing analytics, or similar aspects of the audio source 110. By way of further example and not limitation, potential origin characteristics 140, 141, 142 may comprise one or more physical, mental, or emotional features or states of an origin 160 of the audio source 110. In some non-limiting exemplary embodiments, the first at least one operation and the second at least one operation may be executed by the same artificial intelligence infrastructure.

In some embodiments, an audio source 110 may comprise one or more audio characteristics that may be captured and identified or determined via at least one audio capture device 130. In some aspects, the audio source 110 may comprise audio characteristics of one or more sound waves produced by the vibrations of one or more human vocal cords, the sound of air passing in or out of a human mouth or nose during breathing processes, wheezing or coughing sounds associated with the functioning of human lungs, a resonance occurring in one or more human nasal cavities, or any similar sounds, as non-limiting examples. In some aspects, the audio source 110 may comprise one or more audio characteristics of one or more sound waves that may be directly emitted by a human or one or more reproduced human sounds. By way of example and not limitation, a reproduced sound may comprise one or more live or previously recorded sounds that may be output by at least one audio emitting device instead of being directly emitted from a human or animal. By way of further example and not limitation, in some embodiments, the audio emitting device that produces one or more reproduced sounds may comprise at least one speaker.

As a non-limiting illustrative example, the audio from a conversation between two or more people may be captured, recorded, and processed or analyzed by the audio analytics system 100. In some aspects, the tone, cadence, inflection, and other audio characteristics of the vocal sounds produced by the individuals in the conversation may be captured via at least one audio capture device 130 in the form of, for example and not limitation, a microphone associated with a portable computing device, such as a smartphone or tablet computer that may be proximate to the individuals such that the microphone is able to detect the conversation.

In some aspects, the audio source 110 may be captured by the audio capture device 130 and used by the audio analytics system 100 to determine at least one potential origin characteristic 140, 141, 142 related to an origin 160 of the audio source 110. By way of example and not limitation, a potential origin characteristic 140, 141, 142 of an origin 160 may comprise one or more of: a physical, mental, or emotional condition of the origin 160 of the audio source 110. By way of further example and not limitation, a potential origin characteristic 140, 141, 142 may comprise at least one of: an age, an age range, a height, a height range, a weight, a weight range, a gender, a sex, a hormonal development, a race, an ethnicity, or an identification of the origin 160 of the audio source 110.

As a non-limiting illustrative example, the audio source 110 may comprise a person's voice, which may be captured and processed or analyzed to identify or determine one or more potential origin characteristics 140, 141, 142 regarding the emotional or mental state of the person comprising the origin 160 of the audio source 110. In some implementations, this identification may at least partially comprise the audio analytics system 100 performing or executing at least one operation on the audio source 110. In some aspects, the audio analytics system 100 may comprise at least one storage medium 165, wherein the storage medium 165 may comprise one or more parameters that may be utilized or referenced to at least partially execute the at least one operation on the captured audio source 110. By way of example and not limitation, the parameter(s) within the storage medium 165 may comprise one or more weights, biases, or similar values, modifiers, or inputs that may at least partially influence any resulting output(s) from the at least one operation. In some non-limiting exemplary embodiments, at least a portion of the one or more parameters may be adjustable to modify the accuracy of the potential origin characteristics 140, 141, 142 identified via the execution of the at least one operation on the captured audio source 110.

In some implementations, an audio source 110 may be captured by at least one audio capture device 130. The captured audio source 110 may then be used by the audio analytics system 100 to identify at least one potential origin characteristic 141 associated with the audio source 110. As a non-limiting illustrative example, the audio source 110 may comprise a person's voice, which may be captured and processed or analyzed to identify or determine one or more potential origin characteristics 141 related to the origin 160 of the audio source 110 such as, by way of example and not limitation, one or more physical attributes of the origin 160, i.e., the person speaking. In some embodiments, the audio capture device 130 may comprise at least one storage medium 165, wherein the storage medium 165 may comprise one or more adjustable parameters that may be utilized or referenced during execution of the at least one operation on the captured audio source 110.

In some non-limiting exemplary embodiments, the audio analytics system 100 may comprise one or more parameters that may allow the audio analytics system 100 to identify one or more potential origin characteristics 140, 141, 142 that may be affected by differences in sound waves produced by the vocal cords of humans of different genders, sexes, hormonal developments, ages, heights, weights, races, or ethnicities, as non-limiting examples, as the length, stiffness, vibrational frequency, and/or resonance of vocal cords may be affected by any or all of these factors, thereby causing the vocal cords of different humans to produce sound waves that differ in at least one aspect. By way of example and not limitation, a human voice may be captured and processed or analyzed to identify potential origin characteristics 140, 141, 142 that indicate that a person is likely a 6′5 tall, 55-year-old male that weighs approximately 200 pounds.

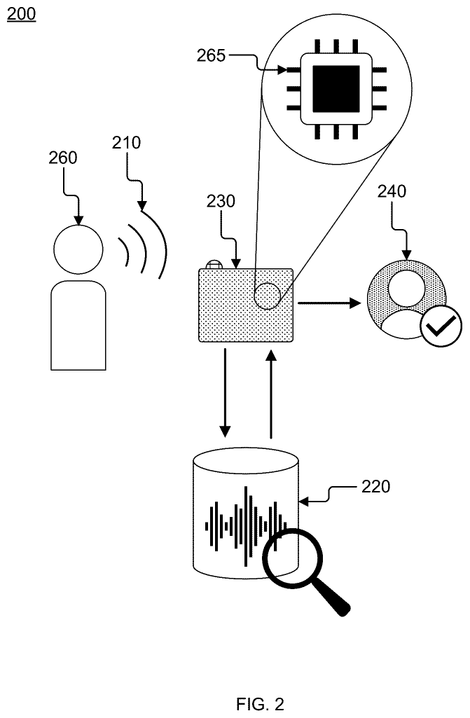

Referring now to FIG. 2, an exemplary audio analytics system 200, according to some embodiments of the present disclosure, is illustrated. In some embodiments, the audio analytics system 200 may comprise at least one audio source 210. In some implementations, the audio analytics system 200 may comprise at least one database 220 and/or at least one storage medium 265. In some embodiments, the audio analytics system 200 may comprise at least one database 220 that is physically and logically separate from the at least one storage medium 265. In some aspects, the audio analytics system 200 may be configured to identify or determine and subsequently present one or more origin characteristic results 240 associated with an origin 260 of the audio source 210. In some implementations, the origin characteristic results 240 may comprise one or more origin characteristics themselves or one or more results of a comparison between potential origin characteristics and expected origin characteristics, which may be helpful, for example and not limitation, when assessing potential fraudulent behavior.

In some embodiments, an audio capture device 230 may at least partially comprise at least one computing device. In some implementations, the audio capture device 230 may be communicatively coupled to at least computing device, such as via a wireless connection or a hardwired connection, as non-limiting examples. In some aspects, the audio capture device 230 may comprise at least one of: a peripheral device and a sensing device.

In some aspects, one or more audio characteristics of one or more sound waves produced by an audio source 210 may be captured and identified and subsequently processed or analyzed via at least one audio capture device 230. In some implementations, the audio capture device 230 may be communicatively coupled to at least one artificial intelligence infrastructure. In some non-limiting exemplary embodiments, the audio capture device 230 may comprise at least one artificial intelligence infrastructure. In some aspects, the artificial intelligence infrastructure may be configured to at least partially execute at least one operation on a captured audio source 210. In some implementations, the artificial intelligence infrastructure may be stored within one or more external or remote computing devices or servers that may be communicatively coupled to the audio capture device 230 via at least one network connection. By way of example and not limitation, in some aspects, the artificial intelligence infrastructure may comprise at least one of: a neural network, a deep neural network, a convolutional neural network, and a support vector machine.

In some aspects, the audio capture device 230 may comprise at least a portion of or may be integrated with one or more audio-based products, such as telephone systems, smartphones, laptop computing devices, hearing aids, or broadcast systems, as non-limiting examples. By way of example and not limitation, an audio capture device 230 may comprise a smartphone programmed with one or more software applications that allows the smartphone to capture and process or otherwise analyze, for example and not limitation, a telephonic communication or other vocal interaction occurring between at least two people, or between at least one person and an audio recording, as non-limiting examples.

In some non-limiting exemplary implementations, an audio source 210 may be captured by at least one audio capture device 230 and cross-referenced with information or data contained in at least one database 220. In some aspects, the database 220 may be communicatively coupled to the audio capture device 230, such as via at least one network connection, or the audio capture device 230 may at least partially comprise the database 220. In some implementations, one or more audio characteristics of the audio source 210 may be identified via execution of a first at least one operation on the captured audio source 210 and a second at least one operation may be executed on the identified audio characteristic(s) to identify one or more potential origin characteristics associated with an origin 260 of the audio source 210. In some non-limiting exemplary embodiments, the first at least one operation may be at least partially executed by a first artificial intelligence infrastructure utilizing a first set of one or more parameters and the second at least one operation may be at least partially executed by a second artificial intelligence infrastructure utilizing a second set of one or more parameters. In some implementations, the first and the second at least one operation may be at least partially executed by the same artificial intelligence infrastructure using the same or different sets of one or more parameters.

In some non-limiting exemplary embodiments, the database 220 may comprise one or more physical memory components configured internally within the audio capture device 230, or the database 220 may comprise one or more external databases or servers to which the audio capture device 230 may be communicatively coupled, such as via wireless connectivity or via a direct wired connection. In some aspects, the database 220 may comprise at least one datum associated with one or more expected origin characteristics related to an origin 260 of a captured audio source 210 that may be compared to one or more potential origin characteristics identified for the origin 260 of the audio source 210 by the audio analytics system 200. In some implementations, the database 220 may comprise a plurality of stored sound waves in the form of, for example and not limitation, audio samples from one or more previously stored audio sources 210 to use as a comparison for a captured audio source 210.

In some non-limiting exemplary implementations, the audio analytics system 200 may be configured to perform at least one comparative analysis to determine one or more origin characteristics results 240 for an audio source 210. In some non-limiting exemplary embodiments, the comparative analysis may at least partially comprise a direct or indirect comparison between one or more identified potential origin characteristics associated with an origin 260 of an audio source 210, wherein the potential origin characteristics may be cross-referenced with one or more expected origin characteristics for the origin 260 that may be stored within the database 220. In some aspects, at least a portion of the expected origin characteristics may be at least partially identified from one or more audio samples previously stored within the database 220.

As a non-limiting illustrative example, a phone call between a person and a bank may be captured using at least one audio capture device 230, and the audio capture device 230 may facilitate the real-time execution of a first at least one operation on a data stream comprising the caller's voice to identify one or more audio characteristics of the voice, after which a second at least one operation may be executed on the data stream to identify one or more potential origin characteristics of the caller. In some aspects, the identified potential origin characteristics may cross-referenced against one or more expected origin characteristics within at least one database 220 to attempt to verify the identity of the caller. In some non-limiting exemplary implementations, the caller's voice may be directly compared to a plurality of voice recordings stored within the database 220 such that the audio analytics system 200 may attempt to match the caller's voice to at least one previously-recorded voice sample obtained from the caller. For example, the database 220 may comprise one or more recordings of previous calls the caller made to the bank or other institutions, and the audio analytics system 200 may compare the caller's voice with those stored phone conversations to determine whether the caller is the same person as in the recordings.

As an additional illustrative example, an individual may call a bank or other financial institution and claim to be the owner of one or more accounts. The bank records may indicate that the owner of the relevant account is a 65-year-old female, wherein the age and gender data may comprise actual expected origin characteristics of the account owner. In some aspects, the audio analytics system 200 may execute at least one operation on the data stream comprising the caller's voice to identify one or more potential origin characteristics associated with the caller. In some implementations, the audio analytics system 200 may then make a comparative determination between the identified potential origin characteristics of the caller's voice and the expected origin characteristics comprising the age and gender of the actual account holder stored within the database 220 to determine origin characteristic results 240 that may indicate whether the caller may be a 65-year-old female, wherein a negative determination may indicate that the caller may be engaging in fraudulent behavior.

In some aspects, the audio analytics system 200 may comprise at least one artificial intelligence infrastructure that may be at least partially trained using an amount of training data, wherein the training data may be derived from a plurality of training sources, wherein each of the training sources may comprise at least one type or form of sound or audio that comprises one or more sound waves. In some non-limiting exemplary embodiments, the artificial intelligence infrastructure may comprise at least three layers, wherein each layer may comprise one or more nodes. By way of example and not limitation, the artificial intelligence infrastructure may comprise at least one input layer, at least one output layer, and one or more hidden intermediate layers. In some aspects, the nodes of one layer may be connected to the nodes of an adjacent layer via one or more channels. In some implementations, each channel may be assigned a numerical value, or weight. In some embodiments, each node within the one or more intermediate layers may be assigned a numerical value, or bias. Collectively, the weights of the channels and the biases of the nodes may comprise one or more parameters of the audio analytics system 200.

In some aspects, the training data may be received by the input layer of the artificial intelligence infrastructure. In some implementations, the audio analytics system 200 may then execute one or more operations on the training data as the training data is propagated through the one or more intermediate layers, wherein the one or more operations may incorporate the parameters of the audio analytics system 200 during execution thereof. In some embodiments, once the training data reaches the output layer of the artificial intelligence infrastructure, one or more potential origin characteristics associated with the training data may be identified.

In some implementations, the audio analytics system 200 may be trained via at least one semi-supervised machine learning process. In some aspects, the semi-supervised machine learning process may utilize one or more pseudo-labeling techniques. In some non-limiting exemplary embodiments, each potential origin characteristic identified for the training data received by the audio analytics system 200 may be compared to at least one of: a known (or labeled) origin characteristic for the training data and an estimated (or pseudo-labeled) origin characteristic of the training data. In some aspects, this comparison may allow the audio analytics system 200 to determine if each identified potential origin characteristic of the training data is accurate or inaccurate. In some implementations, if an identified potential origin characteristic is determined to be inaccurate, the audio analytics system 200 may perform one or more calculations to assess the degree or nature of the inaccuracy. In some aspects, the data resulting from this assessment may be directed back through the artificial intelligence infrastructure via at least one backpropagation algorithm. In some non-limiting exemplary embodiments, the at least one backpropagation algorithm may adjust the one or more weights, biases, or other parameters of the audio analytics system 200 to generate more accurate results for subsequently received training data obtained from one or more training sources. In some aspects, the utilization of at least one semi-supervised machine learning process may enable the audio analytics system 200 to process a greater amount of training data from more training sources.

In some aspects, at least a portion of the training data derived from the training sources received by the audio analytics system 200 may be at least partially augmented. In some non-limiting exemplary embodiments, augmenting the training data may at least partially comprise replicating and applying one or more audio quality influencers to the training sources, wherein the audio quality influencers may comprise one or more factors that may affect the quality of audio comprising a training source. By way of example and not limitation, an audio quality influencer may be configured to mimic compression applied to audio sources transmitted via at least one cellular telephone system or one or more user communication services operating on one or more mobile computing devices (such as the WhatsApp® service available from Meta of Menlo Park, CA, a social media network, or a virtual gaming environment, as non-limiting examples).

In some implementations, the determination of the accuracy of the one or more potential origin characteristics identified for each training source received by the audio analytics system 200 of the present disclosure may at least partially comprise the execution of at least one loss function. In some aspects, the loss function may be configured to simultaneously determine classification loss and regression loss for each identified potential origin characteristic such that the audio analytics system 200 may be trained to accurately predict at least one class and/or at least one distribution range for one or more of the potential origin characteristics. By way of example and not limitation, the audio analytics system 200 may be trained to predict an age (e.g., a person is 25 years old) as well as an age range (e.g., a person is between 20 and 30 years old) for an origin 260 of an audio source 210. In some non-limiting exemplary embodiments, the loss function may at least partially comprise at least one linear quadratic estimation algorithm.

In some embodiments, the database 220 may comprise a plurality of databases, servers, and/or other storage media that may collectively serve as a library of previously captured or previously recorded stored training sources. For example, a database 220 may comprise at least one internal library of stored training sources within or integrated with an audio capture device 230 and/or the database 220 may comprise at least one external server to which the audio capture device 230 may be connected by means of at least one network connection, such as the global, public Internet, or a closed local area network (LAN), wherein the network may be used by the audio analytics system 200 to implement a sequential process for scanning the network connections to obtain audio training data and other information from various training sources, such as one or more remote audio capture devices 230 or one or more external privately maintained or publicly available databases 220.

As a non-limiting illustrative example, a database 220 may comprise at least one server that facilitates access to a variety of stored training sources and audio information pertaining to each training source that may be used to train at least one artificial intelligence infrastructure of the audio analytics system 200 to determine at least one potential origin characteristic of at least one captured audio source 210 which may, by way of example and not limitation, provide a confirmation or verification of the identity of the origin 260 of the audio source 210 or may make a determination regarding at least one of: an emotional state, one or more physical characteristics, or a mental state of the origin 260 of the captured audio source 210.

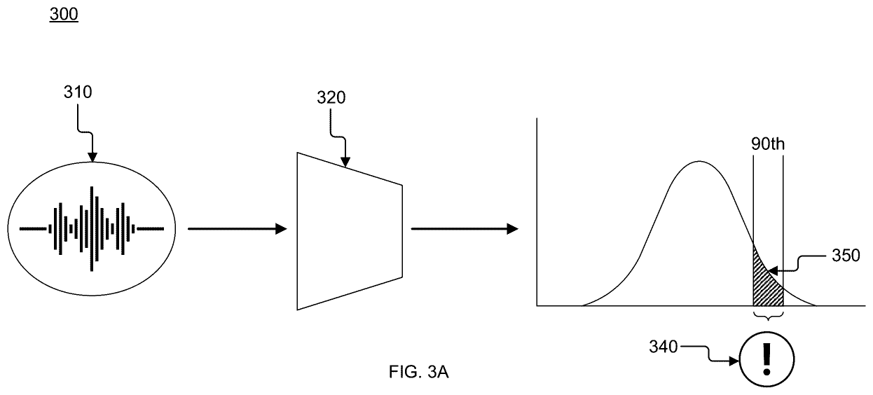

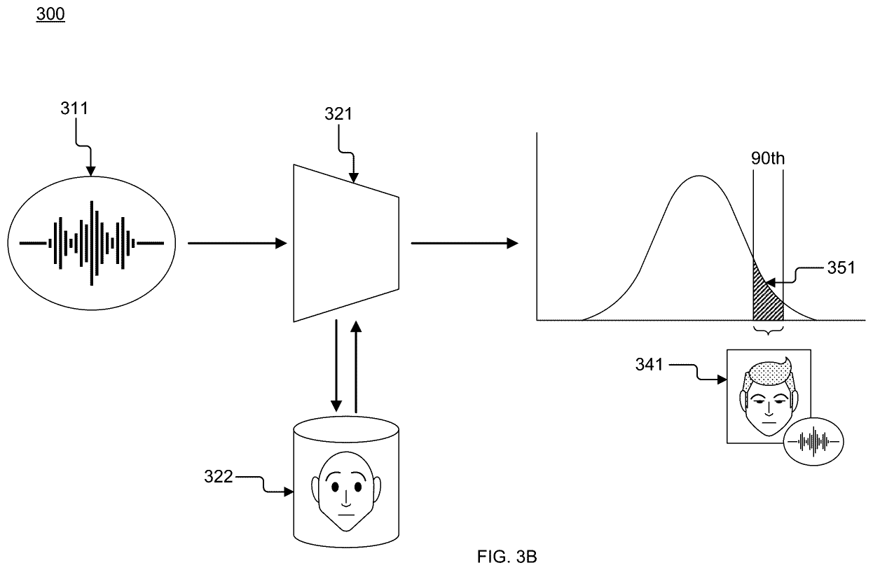

Referring now to FIGS. 3A-B, exemplary scores 350, 351 of an audio analytics system 300, according to some embodiments of the present disclosure, are illustrated. In some embodiments, the audio analytics system 300 may comprise at least one audio source 310, 311. In some aspects, the audio analytics system 300 may comprise at least one visual source 315. In some implementations, the audio analytics system 300 may comprise one or more artificial intelligence infrastructures 320, 321. In some aspects, the audio analytics system 300 may be configured to compute and present one or more scores 350, 351.

In some aspects, the audio analytics system 300 may comprise at least one audio source 310 and at least one artificial intelligence infrastructure 320. In some implementations, an audio source 310 may be captured and propagated through the artificial intelligence infrastructure 320, wherein one or more operations may be executed on the audio source 310 data as it is propagated to identify one or more potential origin characteristics 340 associated with the origin of the audio source 310. In some aspects, the audio analytics system 300 may be configured to compute, generate, and present one or more scores 350 that may be indicative of a confidence level associated with the potential origin characteristics 340 determined by the audio analytics system 300, including an identification of or an identity verification for the origin of the captured audio source 310. In some non-limiting exemplary embodiments, the scores 350 may represent a Bayesian likelihood that each of the potential origin characteristics 340 identified by the artificial intelligence infrastructure 320 is accurate, valid, or true. In some implementations, the scores 350 may be presented in the form of at least one of: one or more bar graphs, one or more line graphs, a normal probability distribution or bell curve, a pie chart, a percentage, or a numerical rank, as non-limiting examples.

As a non-limiting illustrative example, data comprising an unknown person's voice may be propagated through an artificial intelligence infrastructure 320 to identify one or more potential origin characteristics 340 of the person, such as the person's identity. In some aspects, the identified potential origin characteristics 340 may comprise an exact identity for the person, while in other implementations the potential origin characteristics 340 may comprise several possible identities of varying likelihoods for the person that may be identified and presented by the audio analytics system 300. In some aspects, at least one confidence level may be determined by the audio analytics system 300 that may be indicative of an estimated accuracy associated with each possible identity for the unknown person identified by the audio analytics system 300, and this confidence level may be presented by the audio analytics system 300 in the form of, by way of example and not limitation, one or more scores 350.

In some implementations, the audio analytics system 300 may comprise at least one audio source 311. In some embodiments, the audio analytics system 300 may comprise at least one artificial intelligence infrastructure 321. In some aspects, the audio analytics system 300 may be configured to compute and present one or more scores 351. In some implementations, an audio source 311 may be captured and propagated through the artificial intelligence infrastructure 321, wherein one or more operations may be executed on the audio source 311 data as it is propagated to identify one or more potential origin characteristics 341 associated with the origin of the audio source 311. In some non-limiting exemplary embodiments, the identified potential origin characteristics 341 may comprise one or more visual physical features of the origin of the audio source 311. In some aspects, the identified visual physical features of the origin may be compared by the audio analytics system 300 to one or more visual sources 315 stored within at least one database 322 to determine whether the origin of the audio source 311 matches one or more of the stored visual sources 315.

In some embodiments, the audio analytics system 300 may comprise at least one audio source 311. In some embodiments, the audio analytics system 300 may comprise at least one artificial intelligence infrastructure 321. In some aspects, the audio analytics system 300 may be configured to compute and present one or more scores 351. In some implementations, an audio source 311 may be captured and propagated through the artificial intelligence infrastructure 321, wherein at least one operation may be executed on the audio source 311 data as it is propagated to identify one or more potential origin characteristics 341 associated with the origin of the audio source 311. In some aspects, the audio source 311 may comprise one or more sound waves produced by humans that may be associated with one or more origin characteristics that may comprise one or more visual physical attributes of a human face or other portions of a human body. By way of example and not limitation, various audio characteristics of human-produced sound waves may be indicative of potential origin characteristics 341 that may comprise one or more of: nasal cavity size and structure, mouth or nose shape, throat length or width, jaw size or structure, or bone density, as non-limiting examples. In some implementations, a first at least one operation may be executed on the audio source 311 to identify one or more audio characteristics associated with the audio source 311, and a second at least one operation may be executed on the audio source 311 to identify one or more potential origin characteristics 341 comprising visual physical attributes of the origin of the audio source 311. In some aspects, the identified visual physical features of the origin may be compared by the audio analytics system 300 to one or more visual sources 315 stored within at least one database 322 to determine whether the origin of the audio source 311 matches one or more of the stored visual sources 315 to determine an actual or possible identity and/or a more complete visual appearance for the origin of the captured audio source 311.

As a non-limiting illustrative example, data comprising an unknown person's voice may be captured and propagated through at least one artificial intelligence infrastructure 321 to identify one or more potential origin characteristics 341 that may comprise one or more visual physical attributes of the person speaking that may be cross-referenced against one or more visual sources 315 stored within at least one database 322, wherein the stored visual sources 315 may comprise, by way of example and not limitation, a plurality of images or pictures of human faces, to identify one or more stored visual sources 315 that may have produced the captured voice recording. In some embodiments, the audio analytics system 300 may compute or generate at least one confidence level that may be indicative of a likelihood that the captured voice was in fact produced by one of the identified possible visual sources 315. In some aspects, the confidence level may be presented by the audio analytics system 300 in the form of one or more scores 351.

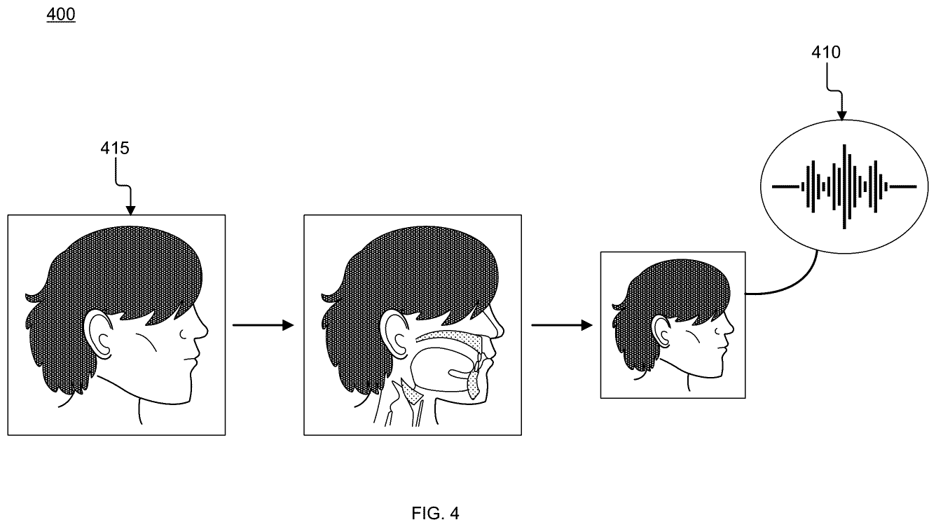

Referring now to FIG. 4, an exemplary audio analytics system 400, according to some embodiments of the present disclosure, is illustrated. In some aspects, the audio analytics system 400 may comprise at least one audio source 410. In some embodiments, the audio analytics system 400 may comprise at least one visual source 415. In some implementations, the visual source 415 may be used to at least partially generate the audio source 410. In some non-limiting exemplary embodiments, the audio analytics system 400 may comprise at least one artificial intelligence infrastructure that may be at least partially trained by executing a first at least one operation on one or more training sources to generate an embedding for the origin of each training source that comprises an identification of a first set of one or more potential characteristics associated with the origins the training sources, wherein a second at least one operation may be executed on the training sources to identify a second set of one or more potential origin characteristics associated with the training source origins, wherein the identified potential origin characteristics may comprise one or more visual physical attributes of a human, such as, by way of example and not limitation, nasal cavity size or structure; mouth or nose shape; throat length or width; lung volume or lung condition; chest size; heart rate, blood pressure, or heart condition as derived from one or more detections pertaining to one or more carotid arteries within or near the neck; skull shape; skin tone; hair color; eye color; muscle tone; muscle condition; muscle responsiveness; jaw size or structure; or bone density, as non-limiting examples. In some aspects, once the artificial intelligence infrastructure has been trained to identify such potential origin characteristics, the audio analytics system 400 may be able to analyze at least one visual source 415 and determine the types of sound waves that may be produced by an origin of an audio source 410 that may comprise visual physical attributes substantially similar to those of the visual source 415, thereby giving an indication of what the visual source 415 may sound like.

As a non-limiting illustrative example, a picture of a person's face may be provided to the audio analytics system 400 as a visual source 415. In some implementations, the picture may then be used by the audio analytics system 400 to analyze the bone structure and/or soft tissue structure of the face and other physical facial attributes and visual physical structures, along with projected or estimated internal structural features pertaining to the subject's face, soft tissue(s), cheek bone(s), nose, mandible, throat, or vocal cords. In some aspects, the audio analytics system 400 may use the results of the analysis to generate an audio source 410 that may comprise a calculated estimation of what the person's voice may sound like based on the visual physical attributes of the visual source 415.

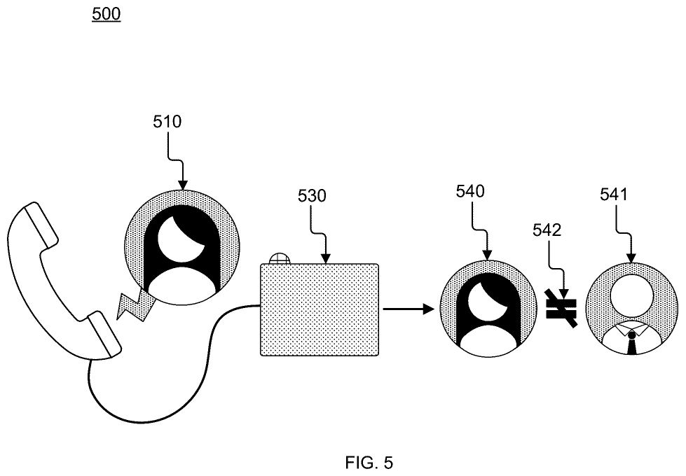

Referring now to FIG. 5, an exemplary origin characteristic result 542 determined by an audio analytics system 500, according to some embodiments of the present disclosure, is illustrated. In some aspects, the audio analytics system 500 may comprise at least one audio source 510. In some implementations, the audio analytics system 500 may comprise at least one audio capture device 530. In some embodiments, the audio analytics system 500 may be configured to determine and present one or more potential origin characteristics 540 or expected origin characteristics 541 associated with an origin of the audio source 510.

By way of example and not limitation, an audio source 510 may comprise a person's voice on a phone call, wherein the audio capture device 530 may be integrated with or communicatively coupled to the phone, either wirelessly or via a direct wired connection, to capture the person's voice. In some non-limiting exemplary embodiments, the audio capture device 530 may comprise the phone itself, which may comprise a smartphone, as a non-limiting example. In some aspects, the audio capture device 530 may comprise at least one storage medium, wherein the storage medium may comprise one or more parameters that may be utilized to at least partially execute at least one operation on the captured audio source 510. By way of example and not limitation, the parameter(s) within the storage medium may comprise one or more weights, biases, or similar values, modifiers, or inputs. In some non-limiting exemplary embodiments, at least a portion of the parameter(s) may be adjustable to modify the accuracy of one or more potential origin characteristics 540 that may be identified via the execution of the at least one operation on the audio source 510.

In some implementations, the audio capture device 530 may be communicatively coupled to at least one artificial intelligence infrastructure. In some non-limiting exemplary embodiments, the audio capture device 530 may comprise at least one artificial intelligence infrastructure. In some aspects, the artificial intelligence infrastructure may be configured to at least partially execute the at least one operation on the captured audio source 510. By way of example and not limitation, in some aspects, the artificial intelligence infrastructure may comprise at least one of: a neural network, a deep neural network, a convolutional neural network, and a support vector machine.

In some aspects, the audio analytics system 500 may be configured to identify one or more audio characteristics of the captured audio source 510. In some implementations, the audio characteristic(s) may be identified via execution of a first at least one operation on the received audio source 610 and a second at least one operation may be executed on the identified audio characteristic(s) to identify the potential origin characteristic(s) 540 associated with an origin of the audio source 510. In some embodiments, the audio analytics system 500 may be configured to execute one or more operations directly on the audio source 510 to identify one or more potential origin characteristics 540 of the origin.

As a non-limiting illustrative example, the audio analytics system 500 may be implemented as a security measure to help prevent individuals from being victimized by fraud. For instance, a bad actor may call an elderly person claiming to be the person's grandson and ask for money. As a security precaution, an audio capture device 530 in the form of the person's phone or integrated with the person's phone system may receive the caller's voice and process the voice data to attempt to verify the identity of the caller and determine whether the caller is actually the grandson of the person being called. In some aspects, this determination may at least partially comprise a comparative analysis between one or more identified potential origin characteristics 540 of the caller and one or more expected origin characteristics 541 identified from a previously captured and stored voiceprint of the actual grandson, wherein the expected origin characteristics 541 may comprise the identity of the grandson. In some embodiments, the comparative analysis performed by the audio analytics system 500 may generate one or more origin characteristic results 542 that may be presented via at least one user interface, such as, for example and not limitation, upon a display screen of a smartphone used by the elderly person during the call.

In some non-limiting exemplary implementations, the origin characteristic results 542 may comprise a determination that the bad actor is not the grandson of the person being called. In some non-limiting exemplary embodiments, the audio analytics system 500 may perform or instigate one or more remedial actions to prevent the bad actor from successfully completing the fraudulent act, such as ending the call, alerting the person being called of the determined security risk, alerting the police or other relevant authorities, and/or alerting a third-party security company or fraud prevention organization, as non-limiting examples.

As another non-limiting illustrative example, an unknown person's voice may be captured and processed or analyzed during a phone call with an insurance agency, bank, or other financial institution or business entity. In some aspects, by way of example and not limitation, at least one audio capture device 530 may be directly or indirectly integrated with the financial institution's phone system such that the audio capture device 530 may be configured to capture the caller's voice and execute one or more operations on the voice data to identify one or more potential origin characteristics 540 of the caller to determine the identity of the caller or verify the identity of the caller to confirm that the caller is the actual policy holder of the relevant policy or account, wherein such identify determination or verification may be presented to one or more employees of the financial institution via at least one user interface. In some aspects, at least one phone used by the financial institution may comprise the audio capture device 530.

In some non-limiting exemplary embodiments, by retrieving a voiceprint of the actual policy or account holder stored in at least one database or accessing such voiceprint from a data stream or file via at least one network connection, the audio analytics system 500 may execute one or more operations on the voiceprint to identify one or more expected origin characteristics 541 of the policy or account holder, and by comparing the expected origin characteristics 541 to one or more identified potential origin characteristics 540 associated with the unknown caller, the audio analytics system 500 may be able to generate one or more origin characteristic results 542 that may comprise a determination that the caller is not the rightful owner of the relevant policy or account, wherein the origin characteristic results 542 may be presented via at least one user interface.

In some non-limiting exemplary implementations, a determination of a fraudulent caller may cause the audio analytics system 500 to perform or instigate one or more remedial actions to prevent any type of fraud from occurring, such as ending the call, alerting the financial institution of the potential security risk, alerting the police or other relevant authorities, and/or alerting a third-party security company or fraud prevention organization, as non-limiting examples. In some aspects, by using a voiceprint analysis to verify the identity of a policy or account owner, the audio analytics system 500 may provide enhanced security by requiring more than general account information and knowledge of a policy or account owner's personal details to access the relevant policy or account.

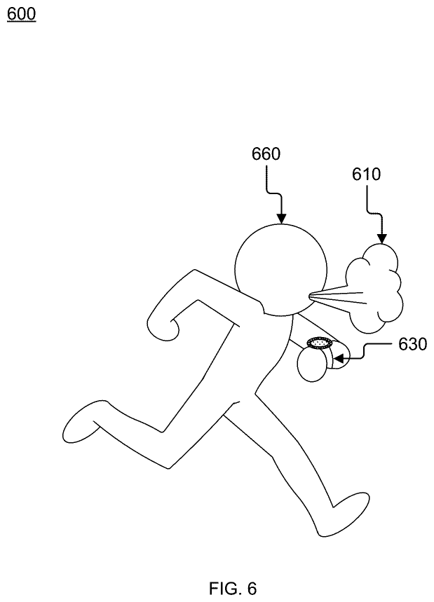

Referring now to FIG. 6, an exemplary audio analytics system 600 comprising an audio source 610 and an audio capture device 630, according to some embodiments of the present disclosure, is illustrated. In some aspects, the audio analytics system 600 may comprise at least one audio source 610. In some implementations, the audio analytics system 600 may comprise at least one audio capture device 630 configured to capture and process or analyze the at least one audio source 610.

In some non-limiting exemplary embodiments, an audio capture device 630 may comprise one or more wearable technology devices, such as a smartwatch or smart glasses, as non-limiting examples, that may be worn on a portion of a user's body, such as, by way of example and not limitation, the user's wrist or head, while the user may be running or engaging in other physical activities. In such aspects, the user may comprise the origin 660 of the audio source 610, which may comprise the user's breathing pattern, breathing intensity, lung sounds, nasal airflow, or similar breath-related noises or sounds, as non-limiting examples. In some implementations, the user's breathing may be captured and processed or analyzed by the audio analytics system 600 to determine one or more potential origin characteristics that may be related to the user's health, such as the user's lung health or breathing capacity, as non-limiting examples.

To further illustrate the previous example, by frequently wearing the audio capture device 630, information regarding the user's breathing or other health-related potential origin characteristics may be regularly received, updated, and managed and used by the audio analytics system 600 to determine whether the user may be experiencing breathing issues or other potential health problems. Additionally, the audio capture device 630 may be used to facilitate an analysis of the user's breathing or other health indicators over time and identify changes in the user's breathing capabilities or other physical health changes.

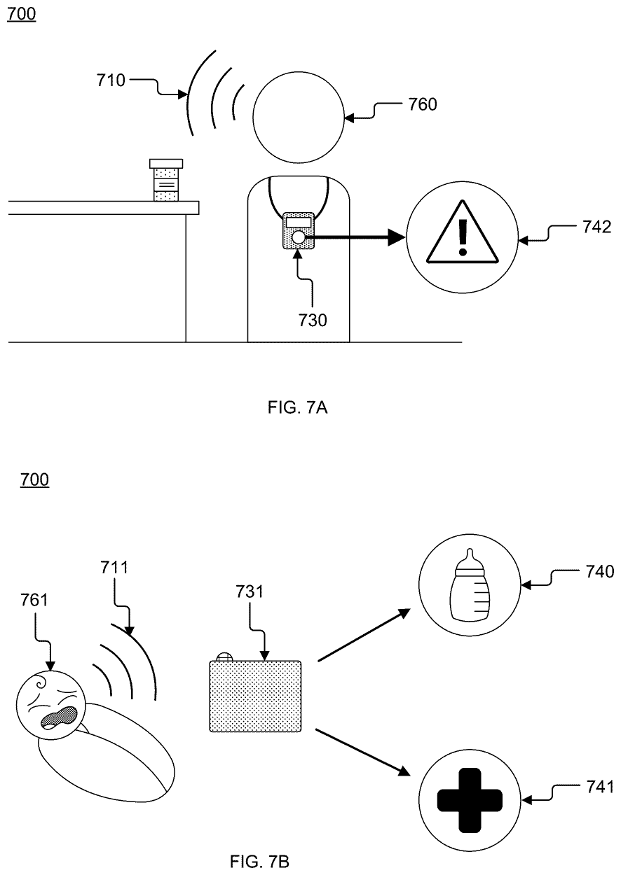

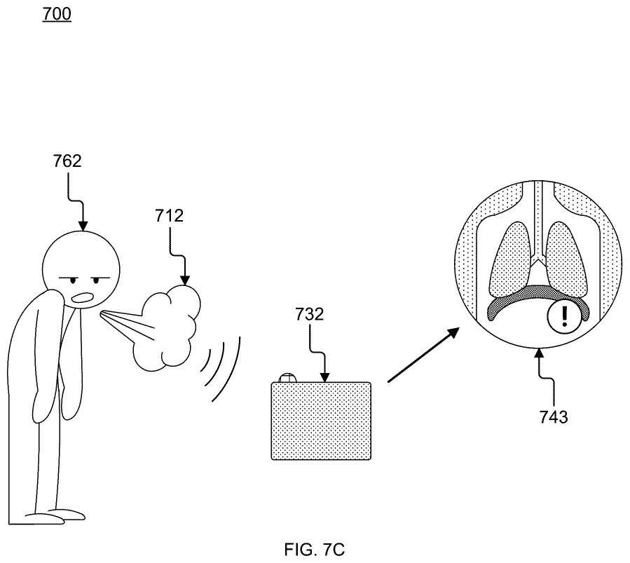

Referring now to FIGS. 7A-C, an exemplary audio analytics system 700 comprising an audio source 710 and an audio capture device 730, according to some embodiments of the present disclosure, is illustrated. In some aspects, the audio analytics system 700 may comprise at least one audio source 710, 711, 712. In some implementations, the audio analytics system 700 may comprise at least one audio capture device 730, 731, 732. In some aspects, the audio analytics system 700 may be configured to identify and present one or more potential origin characteristics 740, 741, 742, 743 related to an origin 760, 761, 762 of the audio source 710, 711, 712.

In some embodiments, the audio analytics system 700 may comprise at least one audio source 710. In some aspects, the audio analytics system 700 may comprise at least one audio capture device 730. In some embodiments, the audio capture device 730 may be configured to capture an audio source 710 to facilitate home medicine monitoring.

As a non-limiting illustrative example, the audio capture device 730 may comprise a wearable technology device, such as a smartwatch, smart glasses, or a device attached to a necklace or wristband, as non-limiting examples, or the audio capture device 730 may comprise a standalone device that may be fixed or placed in a centralized location. In some aspects, by way of example and not limitation, a user of the audio capture device 730 may comprise an origin 760 of an audio source 710, and the user may experience a medical emergency related to negative interactions between two or more ingested medications, and the user's voice may be captured by the audio capture device 730 and the audio capture device 730 may process or analyze the user's voice by executing one or more operations on the user's vocal data to identify one or more potential origin characteristics 742 that may be associated with subtle changes associated with how the interaction of the medications may affect the nerves and muscles associated with the user's vocal cords, thereby recognizing the medical emergency.

To further illustrate this example, the user may experience difficulty breathing, which may be a symptom of a heart attack, and by capturing and identifying audio characteristics associated with the user's disrupted breathing pattern, the audio analytics system 700 may be configured to execute one or more operations on the audio source 710 comprising the breathing pattern to identify one or more potential origin characteristics 742 that may comprise a diagnosis of the heart attack. In some non-limiting exemplary embodiments, upon diagnosing the heart attack or any other medical emergency, the audio capture device 730 may be configured to output one or more forms of communication, such as an automated phone call, text message, or similar notification, to alert one or more relevant authorities or one or more emergency contacts of the user in an at least partiality autonomous fashion so that the user may be able to receive potentially lifesaving medical attention in a timely fashion.

In some implementations, a medical emergency may be detected by the audio analytics system 700 when a user makes an audible declaration of such emergency. In some embodiments, the audio capture device 730 may be configured to continuously monitor a user's voice to identify one or more potential origin characteristics 742 that may be associated with significant or subtle changes in the audio produced by the user that may be indicative of a medical emergency. By way of example and not limitation, a stroke may affect a person's speech pattern, and the audio capture device 730 may allow the audio analytics system 700 to detect the disruption in the person's speech pattern, thereby facilitating the ability of the audio analytics system 700 to identify one or more potential origin characteristics 742 that may comprise a diagnosis of the medical emergency being experienced by the user and, in some aspects, contact one or more first responders or emergency contacts in an at least partially autonomous fashion.

In some aspects, at least one audio capture device 731 may be configured to capture and process an audio source 711 so that the audio analytics system 700 may be able to identify one or more potential origin characteristics 740, 741 of the origin 761 of the audio source 711. As a non-limiting example, parents may place the audio capture device 731 in the vicinity of a child so that the audio capture device 731 may be able to identify one or more potential origin characteristics 740, 741 for the child who may be unable to communicate through speech.

To further illustrate the previous example, the audio capture device 731 may be located so as to capture an audio source 711 from an origin 761 that comprises a baby, and by processing or analyzing the captured audio from the baby, the audio analytics system 700 may be able to execute one or more operations on the audio source 711 to identify one or more potential origin characteristics 740, 741 that may indicate why the baby is making certain noises, such as, by way of example and not limitation, by identifying one or more audio characteristics that comprise subtle differences in crying sounds, and then executing one or more operations on the crying sounds to identify one or more potential origin characteristics 740, 741 that may indicate whether the baby is crying for food or crying in pain, as non-limiting examples.

In some aspects, one or more various types of audible non-verbal human communication may be captured by the audio capture device 731 and processed or analyzed by the audio analytics system 700. By way of example and not limitation, a person who is unable to form words may still be able to communicate, such as by using various sounds that may be indicative of different emotions or feelings, and the audio analytics system 700 may be configured to capture and process or analyze those sounds by executing one or more operations on the sounds to identify one or more potential origin characteristics 740, 741 that may indicate the meaning of the sounds. In some non-limiting exemplary embodiments, this may assist caretakers and others who may have trouble understanding a non-verbal person being cared for, so that better care may be provided.

In some implementations, at least one audio capture device 732 may be configured to capture at least one audio source 712 and thereby enable the audio analytics system 700 to identify one or more potential origin characteristics 743 pertaining to an origin 762 of the captured audio source 712. By way of example and not limitation, a user's voice may comprise an audio source 712 that may be received by the audio capture device 732 and processed or analyzed by the audio analytics system 700, wherein the audio analytics system 700 may execute one or more operations on the audio source 712 to identify one or more audio characteristics to establish a baseline for what the user's voice typically sounds like, wherein the user may comprise the origin 762 of the audio source 712. In some embodiments, this may allow the audio analytics system 700 to execute one or more additional operations on the user's voice subsequently received at a later time to identify one or more audio characteristics that may comprise changes in the user's normal breathing sounds that may comprise, for example and not limitation, subtle or substantial changes in the nasality, breathiness, or similar aspects associated with the user's voice and breathing pattern.

To further illustrate the previous example, muscular dystrophy is a medical condition that may affect the diaphragm of a person and may therefore influence the person's vocal projection, voice tone, and breathing patterns. In some aspects, the audio capture device 732 may be able to identify one or more potential origin characteristics 743 that may comprise a diagnosis of muscular dystrophy at an early stage by recognizing even subtle changes in one or more identified audio characteristics associated with an audio source 712 emitted from an origin 762.

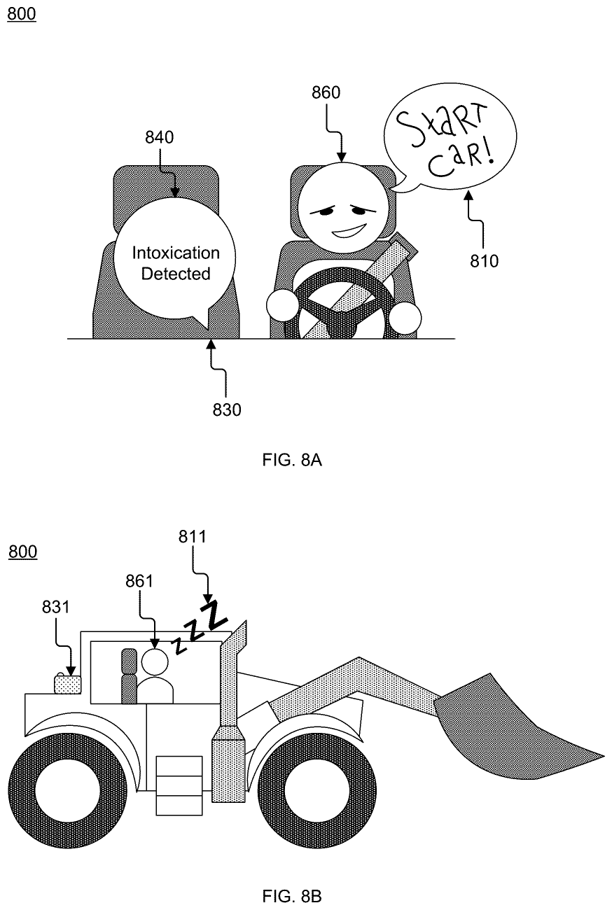

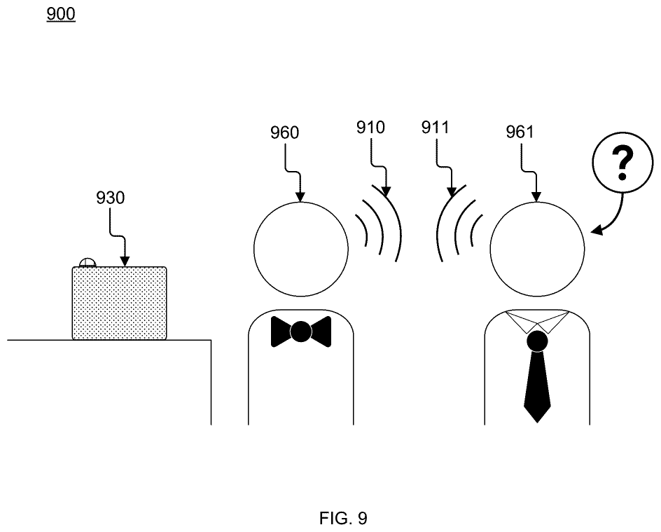

Referring now to FIGS. 8A-B, an exemplary audio analytics system 800 comprising an audio source 810, 811 and an audio capture device 830, 831, according to some embodiments of the present disclosure, is illustrated. In some aspects, the audio analytics system 800 may comprise at least one audio source 810, 811. In some implementations, the audio analytics system 800 may comprise at least one audio capture device 830, 831. In some aspects, the audio analytics system 800 may be configured to identify and present one or more potential origin characteristics 840, 841 related to an origin 860, 861 of the audio source 810, 811.

In some non-limiting exemplary embodiments, an audio capture device 830 may be configured to receive an audio source 810 such that the audio analytics system 800 may be able to execute one or more operations on the audio source 810 to identify one or more potential origin characteristics 840 associated with an origin 860 of the audio source 810 that may indicate that the origin 860 of the audio source 810 may be incapable of completing an action or performing a task. As a non-limiting illustrative example, the audio source 810 may comprise the voice of an intoxicated person, and the audio analytics system 800 may be configured to execute at least one operation on the person's voice that allows the audio analytics system 800 to identify one or more potential origin characteristics 840 that may comprise an indication that the person's vocal cords are being influenced by a depressed central nervous system or other signs of an intoxicated state, wherein the audio analytics system 800 may use the identified potential origin characteristics 840 to determine that the person is intoxicated. In some aspects, by way of example and not limitation, the audio capture device 830 may be installed in a car or other vehicle in a location where the voice of a potential driver of the vehicle may be captured so that the audio analytics system 800 may be able to determine whether the person attempting to operate the vehicle may be intoxicated.

By way of further example and not limitation, in some aspects, the audio analytics system 800 may be integrated into a voice activated starter system of car or other vehicle, wherein the vehicle may be prevented from starting when the audio analytics system 800 determines that the potential driver may be intoxicated; or, the audio analytics system 800 may be configured to alert one or more relevant authorities or provide a warning to the potential driver to deter the individual from operating the vehicle while intoxicated. In some non-limiting exemplary embodiments, the vehicle may only be prevented from starting when the audio analytics system 800 calculates an estimated accuracy of a determined intoxicated state that is above a predetermined minimum threshold value. As a non-limiting illustrative example, the audio analytics system 800 may only prevent a vehicle from starting if the audio analytics system 800 determines that there is at least a 90 percent chance that the potential driver is intoxicated.

In some aspects, at least one audio capture device 831 may be configured to capture an audio source 811 such that the audio analytics system 800 may be able to execute one or more operations on the audio source 811 to identify one or more potential origin characteristics 841 of the origin 861 of the audio source 811 that may indicate that the audio source 811 is incapacitated in some way or is otherwise distracted. As a non-limiting illustrative example, the audio capture device 831 may be located within a vehicle or heavy machinery unit, such as a forklift, in a location that may enable the audio capture device 831 to capture an audio source 811 from an origin 861 that comprises the operator of the vehicle or machinery. In some implementations, by executing at least one operation on data associated with one or more previously captured sounds captured from previous uses of the vehicle or machinery involving the same or different users in a capacitated or lucid state, the audio analytics system 800 may be able to identify one or more expected origin characteristics 841 that may be indicative of such capacitated state, and the audio analytics system 800 may be able to use the expected origin characteristics 841 as a basis for comparison for one or more subsequently identified potential origin characteristics 841 that may be indicative of some form of incapacity, such as when one or more operations may be executed by the audio analytics system 800 on an audio source 811 that comprises one or more vocal sounds produced by fatigued muscles in an operator's vocal cords, thereby causing the audio analytics system 800 to generate one or more origin characteristic results 841 that may comprise a determination that the operator may be asleep, tired, or otherwise incapacitated in some form that would make use of the vehicle or machinery dangerous or unsafe.

Referring now to FIG. 9, an exemplary audio analytics system 900 comprising two or more audio sources 910, 911, according to some embodiments of the present disclosure, is illustrated. In some aspects, the audio analytics system 900 may comprise a plurality of audio sources 910, 911. In some implementations, the audio analytics system 900 may comprise at least one audio capture device 930.

In some aspects, the audio analytics system 900 may comprise two or more audio sources 910, 911. In some embodiments, the audio analytics system 900 may comprise at least one audio capture device 930. In some aspects, the audio capture device 930 may be configured to capture audio from a conversation comprising two audio sources 910, 911 that comprise the voices of human speakers and execute at least one operation on the vocal data to identify one or more potential origin characteristics pertaining to the participants of the captured conversation.

As a non-limiting illustrative example, an audio capture device 930 may be configured to capture and record a conversation that may occur during a job interview, and the audio analytics system 900 may be configured to a receive and process the speech of the interviewer and each potential job candidate. In some aspects, by capturing the conversation, the audio capture device 930 and the audio analytics system 900 may be able to execute a first at least one operation on the audio sources 910, 911 that enables the audio analytics system 900 to identify one or more audio characteristics of the sound waves associated with the voice of each job candidate, whereafter the audio analytics system 900 may subsequently execute a second at least one operation to identify one or more potential origin characteristics that may comprise one or more social status assessments of each candidate, such as the demeanor of the candidate, whether the candidate speaks confidently as a leader, whether the candidate may be shy or afraid of challenges, or whether the candidate may comprise an intense or overbearing personality, as non-limiting examples. In some implementations, by being configured to identify these and other potential origin characteristics for origins 960, 961 of the audio sources 910, 911, the audio analytics system 900 may be able to provide insight as to whether each interviewed job candidate may be a good fit for a job or other social role.

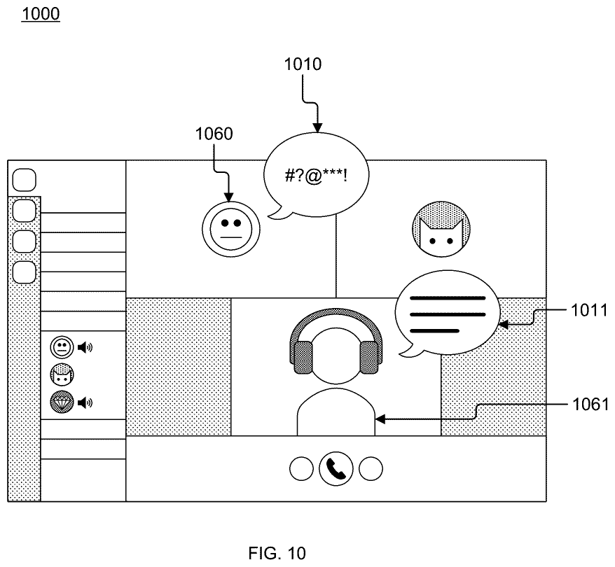

Referring now to FIG. 10, an exemplary audio analytics system 1000 comprising two or more audio sources 1010, according to some embodiments of the present disclosure, is illustrated. In some aspects, the audio analytics system 1000 may comprise a plurality of audio sources 1010, 1011. In some embodiments, by way of example and not limitation, the audio analytics system 1000 may be implemented in an online environment or otherwise configured to capture one or more virtual conversations.

As a non-limiting illustrative example, the audio analytics system 1000 may be integrated with or applied to an online communication platform, such that a plurality of audio sources 1010, 1011 may be continuously monitored and analyzed for, by way of example and not limitation, cyberbullying and other inappropriate behavior. To further illustrate this example, when implemented on an online communication platform, the audio analytics system 1000 may be configured to execute a first at least one operation on each of the plurality of audio sources 1010 that enables the audio analytics system 1000 to identify one or more audio characteristics of one or more sound waves produced by the audio sources 1010, 1011, whereafter the audio analytics system 1000 may subsequently execute a second at least one operation to identify one or more potential origin characteristics that may comprise one or more emotional states that may be associated with aggression or hostility. In some aspects, by way of example and not limitation, an audio source 1010 may comprise an aggressive or hostile tone that may be caused or predicted by an increased tension in the nerves and/or muscles of the vocal cords of an origin 1060 of the audio source 1010; an increase in one or more of: the heart rate, blood pressure, or salivation rate of the origin 1060; mental fatigue or muscle tremors being experienced by the origin 1060; or one or more voice quality features detected for the origin 1060, such as, for example and not limitation, nasality or hoarseness, such that when the audio analytics system 1000 executes the second at least one operation on the audio source 1010, the audio analytics system 1000 may be able to identify the hostile emotional state of the origin 1060 of the audio source 1010 and thereby detect when one or more users of the online communication platform may be engaging in inappropriate speech or behavior on the platform.

In some non-limiting exemplary embodiments, users engaging in inappropriate or harmful behavior on an online communication platform may be automatically reported, penalized, restricted, or removed from the platform by the audio analytics system 1000. In some aspects, this may protect other users of the platform from being recipients of cyberbullying behavior or from otherwise being exposed to inappropriate or harmful online conduct via the platform.

In some implementations, the audio analytics system 1000 may be implemented in an online communication platform, and one or more audio sources 1010, 1011 within the platform may be analyzed when the audio analytics system 1000 executes a first at least one operation on the audio sources 1010 that enables the audio analytics system 1000 to identify one or more audio characteristics of one or more sound waves produced by one or more of the audio sources 1010, whereafter the audio analytics system 1000 may subsequently execute a second at least one operation to identify one or more potential origin characteristics that may comprise one or more emotional states that may be associated with positivity. In some aspects, by way of example and not limitation, an enthusiastic or jovial tone of an audio source 1011 may be caused by relaxed vocal cords or increased projection from the diaphragm of the origin 1061 that may cause a louder or richer sound quality, one or more voice quality features, and/or one or more other sound features or aspects that may be detected or predicted by the audio analytics system 1000, such that when the audio analytics system 1000 executes the second at least one operation on the audio source 1011, the audio analytics system 1000 may be able to identify the positive emotional state of the origin 1061 of the audio source 1011.

In some non-limiting exemplary embodiments, upon completion of an analysis of one or more audio sources 1011, the audio analytics system 1000 may be able to identify positive trends in conversations taking place within an online communication platform and promote these trends to facilitate or maintain a safe communication atmosphere. By way of example and not limitation, the audio analytics system 1000 may be configured to promote one or more positive communication trends by highlighting origins 1061 of audio sources 1011 that engage in positivity or by rewarding positive origins 1061 with prizes or access to exclusive features or content.

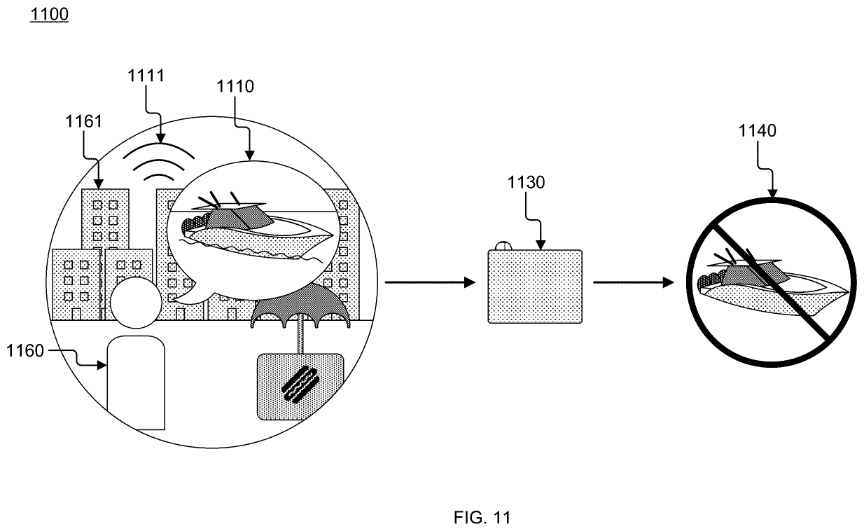

Referring now to FIG. 11, an exemplary audio analytics system 1100 comprising an audio source 1110, according to some aspects of the present disclosure, is illustrated. In some aspects, the audio analytics system 1100 may comprise at least one primary audio source 1110 and at least one secondary audio source 1111. In some implementations, the audio analytics system 1100 may comprise at least one audio capture device 1130. In some aspects, the audio analytics system 1100 may be configured to determine and present one or more origin characteristic results 1140 based at least partially on a comparison between one or more potential origin characteristics associated with at least one of: the origin 1160 of the primary audio source 1110 or the origin 1161 of the secondary audio source 1111.

In some implementations, the audio analytics system 1100 may be configured to execute a first at least one operation on at least one received primary audio source 1110 and/or at least one received secondary audio source 1111 that enables the audio analytics system 1100 to identify one or more potential origin characteristics of the primary audio source and/or the secondary audio source 1111, wherein the secondary audio source 1111 may comprise background noise or environmental or location-based soundscapes. In some aspects, sound waves may be absorbed and reflected differently by different materials, producing various acoustic effects that the audio analytics system 1100 may be able to identify to determine what objects or structures may be proximate to the origin 1160 of the primary audio source 1110 or where the origin 1160 may be located, as non-limiting examples.

As a non-limiting illustrative example, during a phone call, a caller may say that they are enjoying the day out on a boat, wherein the caller's voice may comprise a primary audio source 1110. However, an audio capture device 1130 associated with one or more of the phones used during the call may detect at least one secondary audio source 1111 that comprises at least a portion of the background soundscape of the caller and execute one or more operations on the secondary audio source 1111 to identify at least one potential origin characteristic of the origin 1161 of the secondary audio source 1111 that may indicate that the caller is actually located on land. By way of example and not limitation, the identified potential origin characteristics of the origin 1161 may comprise an identification that the soundscape at least partially comprises a plurality of concrete buildings, a concrete wharf, or background noise that comprises car horns, tire noises on asphalt, and other traffic sounds, as non-limiting examples. In some aspects, the audio analytics system 1100 may further identify one or more potential origin characteristics of the origin 1160 of the primary audio source 1110 that comprise an indication of the claimed location of the origin 1160, such as by recognizing one or more key words, key sounds, or key sound features such as, for example and not limitation, one or more absorbed or reflected sound waves that may indicate the compression of one or more nearby materials or structures. In some implementations, the potential origin characteristics of the origin 1161 of the secondary audio source 1111 may be compared by the audio analytics system 1100 to the potential origin characteristics associated with the origin 1160 of the primary audio source 1110 to determine one or more origin characteristic results 1140 that may indicate that the origin 1160 of the primary audio source 1110 is not at the claimed location.

As an additional non-limiting illustrative example, an employee may comprise an origin 1160 of a primary audio source 1110, wherein the employee may call an employer to request a day off due to feeling sick and wanting to stay home. However, an audio capture device 1130 associated with the employer's phone may detect a secondary audio source 1111 that comprises the background soundscape for the employee and identify one or more potential origin characteristics 1140 related to the origin 1161 of the secondary audio source 1111 that may comprise an identification of background noises that include seagull sounds and ocean waves, thereby allowing the audio analytics system 1100 to recognize that the employee is likely to be on a boat or at the beach and not at home lying in bed.

In some implementations, the audio analytics system 1100 may be configured to identify one or more potential origin characteristics 1140 that may indicate that an audio source 1110 comprises a recording and not a real-time emission from an origin 1160 due to recorded audio sources 1110 comprising various formatting or compression elements. This may be useful, for example and not limitation, in circumstances wherein a recorded audio source 1110 may be used in an attempt to commit a deceitful or fraudulent act.

As a non-limiting illustrative example, a bad actor may call a bank account owner, and during the call the bad actor may record a plurality of words and phrases spoken by the account owner. The bad actor may then use audio equipment to splice the words and phrases in desires ordered sequences such that the bad actor may call the relevant bank and use the recorded voice of the account owner to try to withdraw funds. If the bank's telecommunication infrastructure comprises the audio analytics system 1100, then the audio analytics system 1100 may identify potential audio characteristics 1140 that indicate that the voice is a recording, wherein such indication may be presented to one or more bank employees or administrators to allow them to take one or more precautionary actions to safeguard the account owner's finances.

As an additional non-limiting illustrative example, by being able to distinguish between recorded audio sources 1110 and audio sources 1110 emitted from an origin 1160 in real time, the audio analytics system 1100 may be able to facilitate one or more security or authentication features in an online environment. By way of example and not limitation, a website's performance may be hindered by excessive access by non-human users, or “bots.” In some aspects, by requiring website visitors to input a real-time audio sample to verify they are human, bots' access may be minimized or prevented if an audio analytics system 1100 integrated with the website determines that a received audio sample was pre-recorded, thereby suggesting it was provided by a non-human user attempting to gain access to the site.

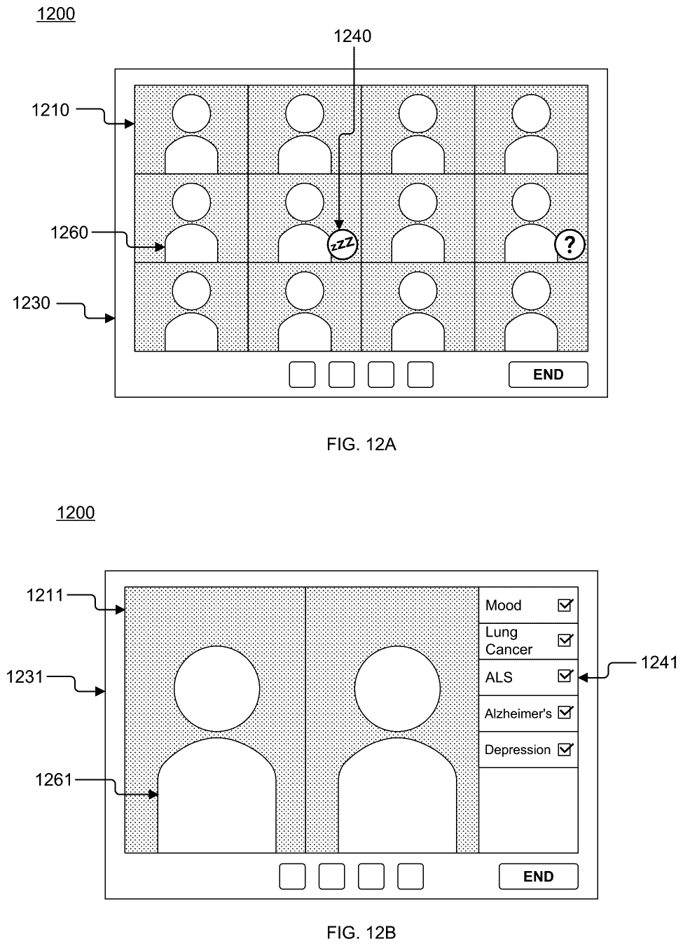

Referring now to FIGS. 12A-B, an exemplary audio analytics system 1200 comprising two or more audio sources 1210, 1211, according to some embodiments of the present disclosure, is illustrated. In some aspects, the audio analytics system 1200 may comprise two or more audio sources 1210, 1211 from two or more origins 1260, 1261. In some implementations, the audio analytics system 1200 may comprise at least one audio capture device 1230, 1231. In some embodiments, the audio analytics system 1200 may be configured to identify and present one or more potential origin characteristics 1240, 1241 related to the origins 1260, 1261 of the audio sources 1210, 1211.

In some aspects, an audio capture device 1230 may be implemented in a group setting to capture and process of analyze one or more audio sources 1210 from one or more origins 1260. As a non-limiting illustrative example, in some implementations, an audio capture device 1230 may comprise a microphone, audio recorder, or other audio receiving device that may be placed in or integrated with a physical or virtual classroom setting to capture and process analyze audio in the form of one or more audio sources 1210 from one or more origins 1260 that comprise students.

To further illustrate the previous example, audio from the students may be captured and processed or analyzed to determine one or more various aspects of the students in the learning environment, such as which students may be paying attention, which students may be understanding the material, or which students may be having trouble understanding the presented information, as non-limiting examples. In some non-limiting exemplary embodiments, the audio analytics system 1200 may be configured to execute a first at least one operation on the audio sources 1210 received from the students that enables the audio analytics system 1200 to identify one or more audio characteristics of one or more sound waves emitted from the students, whereafter a second at least one operation may be executed on the identified audio characteristics to identify one or more potential origin characteristics 1240 that may be related to, for example and not limitation, attentiveness, lexile level, or comprehension.

To further expand on the previous example, a slow, consistent rhythm of deep breathing or snoring from one or more students may be detected by the audio capture device 1230 to allow the audio analytics system 1200 to identify at least one potential origin characteristic 1240 of at least one student that comprises a sleeping state. By way of further example and not limitation, the audio capture device 1230 may detect unusually long periods of silence after a teacher, instructor, or professor has finished speaking, wherein the audio analytics system 1200 may identify at least one potential origin characteristic 1240 for one or more of the students that comprises a lack of comprehension, thereby indicating that the student(s) potentially did not understand what was just said.

In some implementations, an audio capture device 1231 may be implemented in a doctor-patient or other clinical setting to identify one or more potential origin characteristics 1241 for at least one origin 1261, such as a patient, of at least one audio source 1211. As a non-limiting illustrative example, an audio capture device 1231 may be used during a physical or virtual conversation between a therapist and a patient.

In some non-limiting exemplary embodiments, by capturing and processing or analyzing an audio source 1211 from an origin 1261 that comprises a patient, one or more potential origin characteristics 1241 may be identified by the audio analytics system 1200 that may relate to the patient's physical, emotional, or mental state. In some implementations, the audio analytics system 1200 may be configured to execute a first at least one operation on the audio source 1211 that enables the audio analytics system 1200 to identify one or more audio characteristics of one or more sound waves emitted from the patient, whereafter a second at least one operation may be executed on the identified audio characteristics to identify one or more potential origin characteristics 1241 that may comprise various physical, emotional, or mental states of the patient.

By way of example and not limitation, in some aspects the audio capture device 1231 may receive an audio source 1211 that comprises fast speech, rapid breathing, and an elevated pitch that may be associated with tense nerves, muscles, and/or soft tissues of the patient's vocal cords, and so after executing one or more operations on the audio source 1211, the audio analytics system 1200 may identify one or more potential origin characteristics 1241 for the patient that may comprise stress being experienced by the patient.

In some additional non-limiting exemplary implementations, use of the audio analytics system 1200 may be applicable to one or more of a variety of doctor-patient conversations, wherein the potential origin characteristics 1241 identified by the audio analytics system 1200 may comprise one or more physical ailments that may be treated by physicians or other types of medical professionals. In some non-limiting exemplary embodiments, one or more potential origin characteristics 1241 comprising physical ailments may be identified after the audio analytics system 1200 has executed a first at least one operation on at least one audio source 1211 originating from at least one patient that enables the audio analytics system 1200 to identify one or more audio characteristics of one or more sound waves emitted from the patient, whereafter a second at least one operation may be executed in the audio source 1211 to identify one or more potential origin characteristics 1241 for the patent that may comprise one or more physical ailments.

By way of example and not limitation, an audio source 1211 received from a patient that comprises a raised pitch and increased breathiness may be processed by the audio analytics system 1200 to identify at least one potential origin characteristic 1241 for the patient that comprises a sensation of physical pain due to tensed muscles and nerves within the patient's vocal cords and diaphragm. By way of further example and not limitation, in some aspects, the audio capture device 1231 may receive at least one audio source 1211 from the patient, wherein after executing a first at least one operation on the audio source 1211, the audio analytics system 1200 may identify one or more audio characteristics that comprise a tone or pitch that may be associated with a change in the resonation of sound within the patient's nasal cavities, and so after executing a second at least one operation on the identified audio characteristics, the audio analytics system 1200 may identify one or more potential origin characteristics 1241 that may comprise a diagnosis that the patient may be experiencing nasal congestion or a respiratory condition, as non-limiting examples.

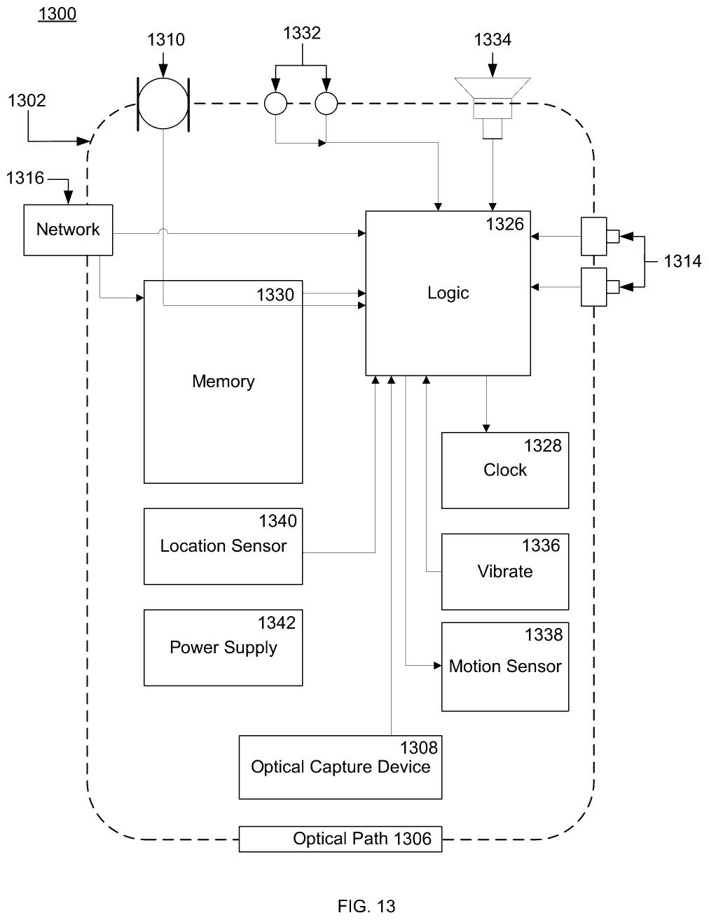

Referring now to FIG. 13, a block diagram of an exemplary computing device 1302 that may at least partially comprise an audio analytics system, according to some embodiments of the present disclosure, is illustrated. The computing device 1302 may comprise an optical capture device 1308, which may capture an image and convert it to machine-compatible data, and an optical path 1306, typically a lens, an aperture, or an image conduit to convey the image from a rendered document to the optical capture device 1308. The optical capture device 1308 may incorporate a Charge-Coupled Device (CCD), a Complementary Metal Oxide Semiconductor (CMOS) imaging device, or an optical sensor of another type.

In some embodiments, the computing device 1302 may comprise a microphone 1310, wherein the microphone 1310 and associated circuitry may convert the sound of the environment, including spoken words, into machine-compatible signals. Input facilities 1314 may exist in the form of buttons, scroll-wheels, or other tactile sensors such as touch-pads. In some embodiments, input facilities 1314 may include a touchscreen display. Visual feedback 1332 to the user may occur through a visual display, touchscreen display, or indicator lights. Audible feedback 1334 may be transmitted through a loudspeaker or other audio transducer. Tactile feedback may be provided through a vibration module 1336.

In some aspects, the computing device 1302 may comprise a motion sensor 1338, wherein the motion sensor 1338 and associated circuitry may convert the motion of the computing device 1302 into machine-compatible signals. For example, the motion sensor 1338 may comprise an accelerometer, which may be used to sense measurable physical acceleration, orientation, vibration, and other movements. In some embodiments, the motion sensor 1338 may comprise a gyroscope or other device to sense different motions.

In some implementations, the computing device 1302 may comprise a location sensor 1340, wherein the location sensor 1340 and associated circuitry may be used to determine the location of the device. The location sensor 1340 may detect Global Position System (GPS) radio signals from satellites or may also use assisted GPS where the computing device 1302 may use a cellular network to decrease the time necessary to determine location. In some embodiments, the location sensor 1340 may use radio waves to determine the distance from known radio sources such as cellular towers to determine the location of the computing device 1302. In some embodiments these radio signals may be used in addition to and/or in conjunction with GPS.

In some aspects, the computing device 1302 may comprise a logic module 1326, which may place the components of the computing device 1302 into electrical and logical communication. The electrical and logical communication may allow the components to interact. Accordingly, in some embodiments, the received signals from the components may be processed into different formats and/or interpretations to allow for the logical communication.

The logic module 1326 may be operable to read and write data and program instructions stored in associated storage 1330, such as RAM, ROM, flash, or other suitable memory. In some aspects, the logic module 1326 may read a time signal from the clock unit 1328. In some embodiments, the computing device 1302 may comprise an on-board power supply 1342. In some embodiments, the computing device 1302 may be powered from a tethered connection to another device, such as a Universal Serial Bus (USB) connection.

In some implementations, the computing device 1302 may comprise a network interface 1316, which may allow the computing device 1302 to communicate and/or receive data to a network and/or an associated computing device. The network interface 1316 may provide two-way data communication.

For example, the network interface 1316 may operate according to an internet protocol. As another example, the network interface 1316 may comprise a local area network (LAN) card, which may allow a data communication connection to a compatible LAN. As another example, the network interface 1316 may comprise a cellular antenna and associated circuitry, which may allow the computing device 1302 to communicate over standard wireless data communication networks. In some implementations, the network interface 1316 may comprise a Universal Serial Bus (USB) to supply power or transmit data. In some embodiments, other wireless links known to those skilled in the art may also be implemented.

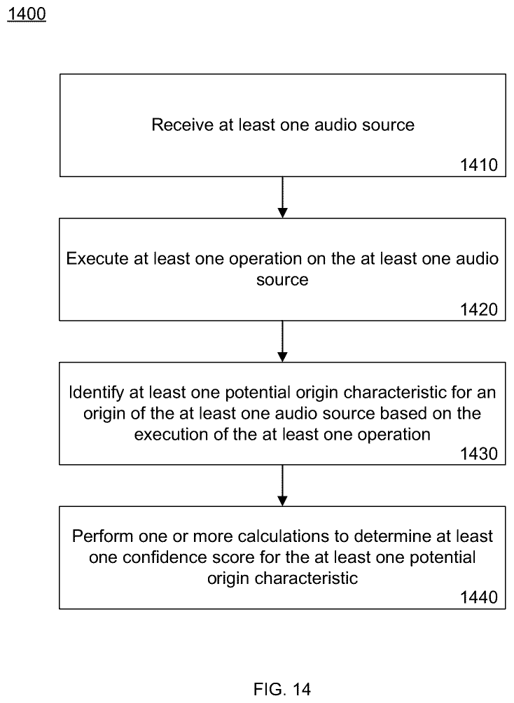

Referring now to FIG. 14, an exemplary process 1400 for analyzing audio, according to some embodiments of the present disclosure, is illustrated. In some non-limiting exemplary implementations, process 1400 may be at least partially implemented via an audio analytics system. In some aspects, at 1410, process 1400 may comprise receiving at least one audio source from at least one origin. In some implementations, the audio source may comprise one or more audio characteristics. In some embodiments, the audio source may be received via at least one audio capture device. In some aspects, the audio source may comprise a data stream received in substantially real time.

In some aspects, at 1420, process 1400 may comprise executing at least one operation on the received audio source. In some implementations, at least one parameter may be referenced during the execution of the at least one operation, wherein the at least one parameter may be stored within at least one storage medium. In some non-limiting exemplary embodiments, the at least one operation may be executed on the audio source in situ.

In some aspects, at 1430, process 1400 may comprise identifying at least one potential origin characteristic related to the origin of the audio source based on the execution of the at least one operation. In some implementations, the identified potential origin characteristic(s) may comprise at least one of: at least one physical attribute, at least one mental state, or at least one emotional state. In some non-limiting exemplary embodiments, the at least one physical attribute may comprise at least one of: an age, an age range, a gender, a sex, a hormonal development, a height, and a weight; the at least one mental state may comprise at least one of: a level of neurological impairment, an intoxicated state, or a fatigued status; and the at least one emotional state may comprise at least one of: a stress level, an anxiety level, or state of depression, sadness, anger, or happiness.

In some aspects, at 1440, process 1400 may comprise performing one or more calculations to determine at least one confidence score associated with the identified potential origin characteristic(s). In some embodiments, the confidence score may comprise a quantified representation of an estimated accuracy of the identified potential origin characteristic(s). In some implementations, the confidence score may at least partially comprise a determination of at least one quality aspect of the audio source, wherein the confidence score may be at least partially affected by the audio source quality. By way of example and not limitation, if the audio source comprises background noise that obscures the tone and frequency of the audio source, then the confidence score may reflect the low quality of the audio source. In some embodiments, the confidence score may at least partially comprise an expected accuracy associated with at least one of the identified potential origin characteristics. By way of example and not limitation, if an identified potential origin characteristic comprises an age range for an origin of an audio source that spans from 40 years old to 50 years old, and a high level of accuracy is expected for that age range, then the high expected accuracy may be reflected by an increased confidence score.

In some implementations, the confidence score may be dynamically determined for each of one or more audio samples received or derived from one or more audio sources, wherein each audio sample may comprise, by way of example and not limitation, an amount of previously-recorded audio data or an amount of audio data streamed in substantially real time, as non-limiting examples. In some aspects, the confidence score may be at least partially based on one or more features or elements of a unique audio sample, such that the confidence score may increase or decrease based on the presence or absence of such features or elements.

By way of example and not limitation, the confidence score may be at least partially based upon whether an audio sample comprises one or more of: at least one verbalization of one or more phonemes, an amount of background noise, one or more formatting or compression elements, one or more missing or lost data packets, a high or low signal clarity, a high or low amplitude, high or low energy, or one or more degradations in quality, as non-limiting examples. In some implementations, the confidence score may be at least partially determined by at least one artificial intelligence infrastructure. In some embodiments, the artificial intelligence infrastructure may be configured to analyze at least a portion of a spectrogram of an audio sample to identify the presence or absence of one or more features or elements that may at least partially affect the confidence score.

As a non-limiting illustrative example, the phoneme that comprises the long “a” sound may be associated with one or more features of the neck of an origin of an audio source. In some aspects, an audio sample that comprises a high signal clarity and high energy for one or more occurrences of the long “a” phoneme may comprise a higher confidence score than a similar audio sample that does not comprise such elements or features, as a non-limiting example.

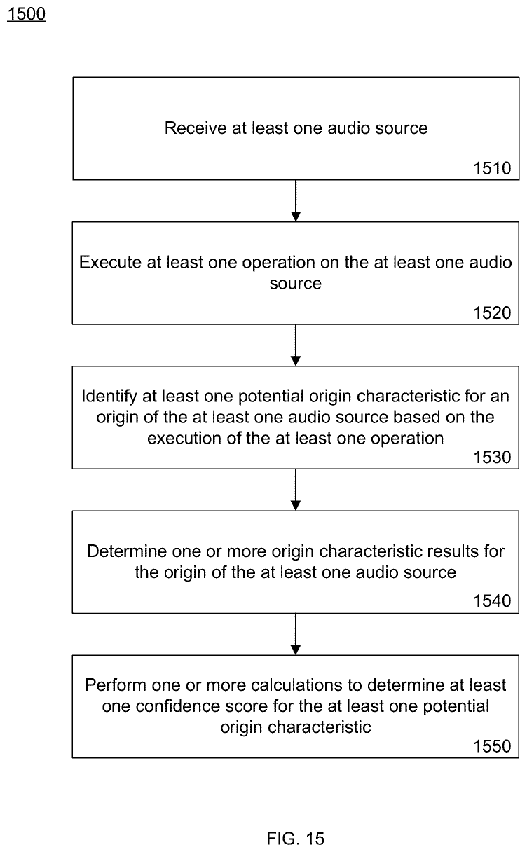

Referring now to FIG. 15, an exemplary process 1500 for identifying a potentially fraudulent audio source, according to some embodiments of the present disclosure, is illustrated. In some non-limiting exemplary implementations, process 1500 may be at least partially implemented via an audio analytics system. In some aspects, at 1510, process 1500 may comprise receiving at least one audio source from at least one origin. In some implementations, the audio source may comprise one or more audio characteristics. In some embodiments, the audio source may be received via at least one audio capture device. In some aspects, the audio source may comprise a data stream received in substantially real time.

In some aspects, at 1520, process 1500 may comprise executing at least one operation on the received audio source. In some implementations, at least one parameter may be referenced during the execution of the at least one operation, wherein the at least one parameter may be stored within at least one storage medium. In some non-limiting exemplary embodiments, the at least one operation may be executed on the audio source in situ.

In some aspects, at 1530, process 1500 may comprise identifying at least one potential origin characteristic related to the origin of the audio source based on the execution of the at least one operation. In some implementations, the identified potential origin characteristic(s) may comprise at least one of: at least one physical attribute, at least one mental state, or at least one emotional state. In some non-limiting exemplary embodiments, the at least one physical attribute may comprise at least one of: an age, an age range, a gender, a sex, a hormonal development, a height, and a weight; the at least one mental state may comprise at least one of: a level of neurological impairment, an intoxicated state, or a fatigued status; and the at least one emotional state may comprise at least one of: a stress level, an anxiety level, or state of depression, sadness, anger, or happiness.

In some aspects, at 1540, process 1500 may comprise determining one or more origin characteristic results for the origin of the audio source. In some implementations, the origin characteristic results may be at least partially based on a comparison between the potential origin characteristics identified for the origin of the audio source and one or more expected origin characteristics for the origin of the audio source.

In some non-limiting exemplary embodiments, the expected origin characteristics may comprise one or more physical, mental, or emotional features or states associated with a known true origin of the audio source, such that at least one discrepancy between the potential origin characteristics identified by the audio analytics system and the expected origin characteristics may indicate that the origin of the received audio source is not the true origin, which may cause the audio analytics system to identify the audio source as potentially fraudulent.

By way of example and not limitation, a bad actor may call a bank, falsely claiming to be the owner of an account, wherein the bank's telephone infrastructure may comprise an audio analytics system. The bad actor may have illicitly gained access to the true account owner's name, address, account number, security information, and other data necessary to convince a bank representative that the bad actor is the true owner of the account. However, the audio analytics system may comprise at least one database or similar storage medium that comprises one or more expected origin characteristics for the true account owner, which may indicate that the rightful owner of the account is a sixty-year-old male. During the call, the audio analytics system may identify one or more potential origin characteristics for the bad actor that indicate that the caller is a thirty-year-old male. This discrepancy between the expected origin characteristics and the identified potential origin characteristics may cause the audio analytics system to identify the audio source comprising the voice of the bad actor as being potentially fraudulent. In some embodiments, the audio analytics system may present one or more notifications to the bank representative indicating the potentially fraudulent audio source.

In some aspects, at 1550, process 1500 may comprise performing one or more calculations to determine at least one confidence score associated with the identified potentially fraudulent audio source. In some embodiments, the confidence score may comprise a quantified representation of an estimated accuracy of the identified potentially fraudulent audio source. In some implementations, the confidence score may at least partially comprise a determination of at least one quality aspect of the audio source, wherein the confidence score may be at least partially affected by the audio source quality. By way of example and not limitation, if the audio source comprises background noise that obscures the tone and frequency of the audio source, then the confidence score may reflect the low quality of the audio source. In some embodiments, the confidence score may at least partially comprise an expected accuracy associated with at least one of the identified potential origin characteristics. By way of example and not limitation, if an identified potential origin characteristic comprises an age range for an origin of an audio source that spans from 30 years old to 40 years old, and a high level of accuracy is expected for that age range, then the high expected accuracy may be reflected by an increased confidence score.

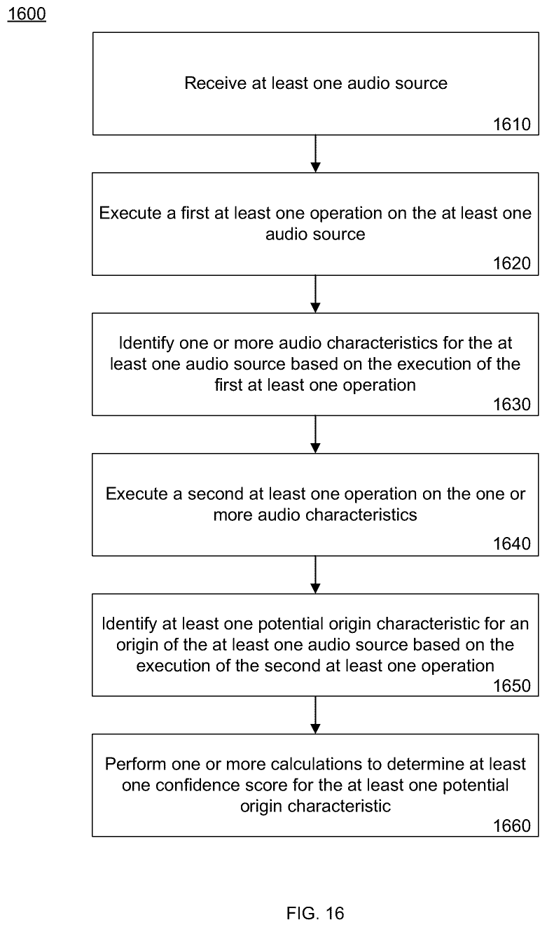

Referring now to FIG. 16, an exemplary process 1600 for analyzing audio, according to some embodiments of the present disclosure, is illustrated. In some non-limiting exemplary implementations, process 1600 may be at least partially implemented via an audio analytics system. In some aspects, at 1610, process 1600 may comprise receiving at least one audio source from at least one origin. In some implementations, the audio source may comprise one or more audio characteristics. In some embodiments, the audio source may be received via at least one audio capture device. In some aspects, the audio source may comprise a data stream received in substantially real time.

In some aspects, at 1620, process 1600 may comprise executing a first at least one operation on the received audio source. In some implementations, a first at least one parameter may be referenced during the execution of the first at least one operation, wherein the first at least one parameter may be stored within at least one storage medium. In some non-limiting exemplary embodiments, the first at least one operation may be executed on the audio source in situ.

In some aspects, at 1630, process 1600 may comprise identifying one or more audio characteristics of the received audio source based on the execution of the first at least one operation. In some non-limiting exemplary embodiments, the identified audio characteristics may comprise at least one of: volume, tone, rhythm, inflection, pitch, base, frequency, or one or more image processing analytics.

In some aspects, at 1640, process 1600 may comprise executing a second at least one operation on the received audio source, wherein the second at least one operation may be executed on the identified audio characteristics of the audio source. In some implementations, a second at least one parameter may be referenced during the execution of the second at least one operation, wherein the second at least one parameter may be stored within at least one storage medium. In some aspects, the second at least one parameter may be the same as the first at least one parameter. In some non-limiting exemplary embodiments, the second at least one operation may be executed on the audio source in situ.

In some aspects, at 1650, process 1600 may comprise identifying at least one potential origin characteristic related to the origin of the audio source based on the execution of the second at least one operation. In some implementations, the identified potential origin characteristic(s) may comprise at least one of: at least one physical attribute, at least one mental state, or at least one emotional state. In some non-limiting exemplary embodiments, the at least one physical attribute may comprise at least one of: an age, an age range, a gender, a sex, a hormonal development, a height, and a weight; the at least one mental state may comprise at least one of: a level of neurological impairment, man intoxicated state, or a fatigued status; and the at least one emotional state may comprise at least one of: a stress level, an anxiety level, or state of depression, sadness, anger, or happiness.

In some aspects, at 1660, process 1600 may comprise performing one or more calculations to determine at least one confidence score associated with the identified potential origin characteristic(s). In some embodiments, the confidence score may comprise a quantified representation of an estimated accuracy of the identified potential origin characteristic(s). In some implementations, the confidence score may at least partially comprise a determination of at least one quality aspect of the audio source, wherein the confidence score may be at least partially affected by the audio source quality. By way of example and not limitation, if the audio source comprises background noise that obscures the tone and frequency of the audio source, then the confidence score may reflect the low quality of the audio source. In some embodiments, the confidence score may at least partially comprise an expected accuracy associated with at least one of the identified potential origin characteristics. By way of example and not limitation, if an identified potential origin characteristic comprises an age range for an origin of an audio source that spans from 40 years old to 50 years old, and a high level of accuracy is expected for that age range, then the high expected accuracy may be reflected by an increased confidence score.

### Conclusion

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). There may be various components of the present invention that are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

What is claimed is:

1. A method for analyzing audio, comprising:
receiving at least one audio source, wherein the at least one audio source is emitted from at least one origin;
executing a first at least one operation on the at least one audio source, wherein execution of the at least one operation references at least one parameter, wherein the at least one parameter is stored in at least one storage medium; and
identifying at least one potential origin characteristic of the at least one audio source based on the execution of the first at least one operation.

2. The method of claim 1, wherein the method further comprises:
determining at least one confidence score of the at least one potential origin characteristic, wherein the at least one confidence score comprises an estimated accuracy of the at least one potential origin characteristic.

3. The method of claim 1, wherein the method further comprises:
executing a second at least one operation on the at least one audio source.

4. The method of claim 3, wherein the method further comprises:
identifying at least one audio characteristic of the at least one audio source based on the execution of the second at least one operation.

5. The method of claim 4, wherein execution of the first at least one operation and execution of the second at least one operation are each at least partially facilitated by one or more of: at least one neural network, at least one deep neural network, and at least one machine learning process.

6. The method of claim 1, wherein the receiving of the at least one audio source occurs via at least one audio capture device.

7. The method of claim 1, wherein the at least one audio source comprises at least one human voice.

8. The method of claim 1, wherein the at least one potential origin characteristic comprises at least one of:
at least one physical attribute, at least one mental state, and at least one emotional state of the at least one origin.

9. The method of claim 8, wherein the at least one physical attribute comprises at least one of: an age, an age range, a gender, a sex, and a height.

10. The method of claim 8, wherein the at least one emotional state comprises a stress level.

11. The method of claim 8, wherein the at least one mental state comprises at least one of: a neurological impairment level, an intoxicated state, and a fatigued condition.

12. The method of claim 1, wherein the at least one audio source is at least temporarily stored in at least one database.

13. The method of claim 12, wherein the at least one database is physically and logically separate from the at least one storage medium.

14. The method of claim 1, wherein the executing of the first at least one operation on the at least one audio source occurs in situ.

15. The method of claim 1, wherein the at least one audio source is received via data streaming in substantially real time.

16. The method of claim 1, wherein the method further comprises:
determining at least one origin characteristic result for the at least one audio source, wherein the at least one origin characteristic result is at least partially based on a comparison between the at least one potential origin characteristic and at least one expected origin characteristic.

17. The method of claim 16, wherein the method further comprises:
identifying the at least one audio source as being potentially fraudulent, wherein identification of a potentially fraudulent audio source is at least partially based on at least one discrepancy between the at least one potential origin characteristic and the at least one expected origin characteristic.

18. The method of claim 2, wherein the at least one confidence score at least partially comprises a determination of at least one quality aspect of the at least one audio source.

19. The method of claim 2. wherein the at least one confidence score at least partially comprises an expected accuracy associated with the at least one potential origin characteristic.

20. The method of claim 1, wherein the at least one potential origin characteristic comprises a class and a distribution range.
